(19) United States
(12) Patent Application Publication
(10) Pub. No.: US 2025/0324021 A1
(43) Pub. Date: Oct. 16, 2025

(54) IMAGE PROJECTION DEVICE

(71) Applicant: GUANGDONG OPPO MOBILE TELECOMMUNICATIONS CORP., LTD., Dongguan (CN)

(72) Inventors: Yoji OKAZAKI, Yokohama (JP); Tatsuya NAKATSUJI, Yokohama (JP)

(21) Appl. No.: 19/245,870

(22) Filed: Jun. 23, 2025

Related U.S. Application Data
(63) Continuation of application No. PCT/CN2022/143588, filed on Dec. 29, 2022.

(51) Int. Cl. H04N 9/31; G02B 27/01

(52) U.S. Cl. CPC H04N 9/3161; H04N 9/3129; H04N 9/317; G02B 27/0172; G02B 27/0179; G02B 2027/0187

(57) ABSTRACT

An image projection device includes a light source, a scanner, a projection optical system, a visual line direction detector, and an optical system controller. The light source irradiates a laser beam. The scanner scans the laser beam irradiated from the light source. The projection optical system irradiates the laser beam scanned by the scanner and projects an image to a user's retina. The visual line direction detector that detects a user's visual line direction for which the image is projected. The optical system controller that controls the projection optical system based on the visual line direction detected by the visual line direction detector. The light source includes at least one first laser element that irradiates a laser of a first color, at least one second laser element that irradiates a laser of a second color, and at least one third laser element that irradiates a laser of a third color.

### CROSS-REFERENCE OF RELATED APPLICATION

The application is a continuation of International Application No. PCT/CN2022/143588 filed on Dec. 29, 2022, the entire disclosures of which are incorporated herein by reference.

### TECHNICAL FIELD

The present disclosure relates to the field of electronic device, and particularly to an image projection device.

### BACKGROUND

In recent years, Augmented Reality (AR) glass, which is an augmented reality type wearable device with a head mount display method, is being developed as an image projection device.

Image projection devices such as the AR glass are required to be small, and have low power consumption and high resolution.

However, in order to meet such a demand for miniaturization or high resolution in various image projection devices such as the AR glass, when a light source or a scanner mounted on the image projection device is downsized, it has been difficult to drive the image projection device with low power consumption since the light source requires an optical output power above a certain amount in order to meet a demand for high resolution. For this reason, high resolution, low power consumption, and downsizing is required for image projection devices such as the AR glass.

### SUMMARY

In accordance with the present disclosure, an image projection device is provided, including:
a light source that irradiates a laser beam;
a scanner that scans the laser beam irradiated from the light source;
a projection optical system that irradiates the laser beam scanned by the scanner and projects an image to a user's retina;
a visual line direction detector that detects a user's visual line direction for which the image is projected; and
an optical system controller that controls the projection optical system based on the visual line direction detected by the visual line direction detector,
wherein the light source comprises:
   at least one first laser element that irradiates a laser of a first color,
   at least one second laser element that irradiates a laser of a second color different from the first color, and
   at least one third laser element that irradiates a laser of a third color different from the first and the second color.

### BRIEF DESCRIPTION OF THE DRAWINGS

These and/or other aspects and advantages of embodiments of the present disclosure will become apparent and more readily appreciated from the following descriptions made with reference to the drawings, in which:

FIG. 1 is a diagram that illustrates an exemplary configuration of the image projection device according to the present disclosure.

FIG. 2 is a diagram that illustrates a current-optical output power characteristics of a first laser element according to the present disclosure.

FIG. 3 is a diagram that illustrates a current-optical output power characteristics of a second laser element according to the present disclosure.

FIG. 4 is a diagram that illustrates a current-optical output power characteristics of a third laser element according to the present disclosure.

FIG. 5 is a diagram that illustrates an exemplary configuration of a light source according to a first embodiment of the present disclosure.

FIG. 6 is a diagram that illustrates another exemplary configuration of the light source according to the first embodiment of the present disclosure.

FIG. 7 is a diagram that illustrates a scanning method of a scanner according to the present disclosure.

FIG. 8 is a diagram that illustrates a space resolution of a scanner according to the present disclosure.

FIG. 9 is a diagram that illustrates an exemplary configuration of a tilt mirror module according to the present disclosure.

FIG. 10 is a diagram that illustrates an exemplary control of the tilt mirror module according to an optical system controller of the present disclosure.

FIG. 11 is a diagram that illustrates an exemplary control of the tilt mirror module according to the optical system controller of the present disclosure.

FIG. 12 is a diagram that illustrates an exemplary control of each laser element according to a light source controller of the present disclosure.

FIG. 13 is a diagram that illustrates an exemplary configuration of the light source according to a second embodiment of the present disclosure.

FIG. 14 is a diagram that describes a configuration of a plurality of first laser elements according to the second embodiment of the present disclosure.

FIG. 15 is a diagram that describes a configuration of a plurality of second laser elements according to the second embodiment of the present disclosure.

FIG. 16 is a diagram that describes a configuration of a plurality of third laser elements according to the second embodiment of the present disclosure.

FIG. 17 is a diagram that illustrates a relationship between a scanning condition of the scanner and a resolution according to the second embodiment of the present disclosure.

FIG. 18 is a diagram that illustrates the space resolution of a scanner according to the second embodiment of the present disclosure.

FIG. 19 is a diagram that illustrates an exemplary control of each laser element according to the light source controller of the second embodiment of the present disclosure.

FIG. 20 is a diagram that describes an emitter size of the plurality of laser elements according to the modified second example of the second embodiment of the present disclosure.

FIG. 21 is a diagram that illustrates the emitter size for a pitch and a number of beams of the plurality of laser elements according to the modified second example of the second embodiment of the present disclosure.

FIG. 22 is a diagram that illustrates an exemplary configuration of the light source according to a modified third example of the second embodiment of the present disclosure.

FIG. 23 is a diagram that illustrates a beam shifter according to the modified third example of the second embodiment of the present disclosure.

FIG. 24 is a diagram that illustrates another exemplary configuration of the light source according to a modified third example of the second embodiment of the present disclosure.

FIG. 25 is a diagram that illustrates an exemplary configuration of the light source according to a modified fourth example of the second embodiment of the present disclosure.

FIG. 26 is a diagram that illustrates an exemplary control of each laser element according to the light source controller of a modified fourth example of the second embodiment of the present disclosure.

FIG. 27 is a diagram that illustrates an exemplary irradiation of the laser beam of the light source according to a modified fourth example of the second embodiment of the present disclosure.

FIG. 28 is a diagram that illustrates another exemplary configuration of the light source according to a modified fourth example of the second embodiment of the present disclosure.

FIG. 29 is a diagram that illustrates an exemplary configuration of the light source according to a modified first example of the first and second embodiments of the present disclosure.

FIG. 30 is a diagram that illustrates an exemplary configuration of the light source according to the modified second example of the first and second embodiments of the present disclosure.

FIG. 31 is a diagram illustrating an exemplary configuration of the light source according to the modified third example of the first and second embodiments of the present disclosure.

FIG. 32 is a diagram that illustrates an exemplary configuration of the light source according to a modified fourth example of the first and second embodiments of the present disclosure.

FIG. 33 is a diagram that illustrates an exemplary configuration of the light source according to a third embodiment of the present disclosure.

FIG. 34 is a diagram that illustrates an exemplary configuration of the light source according to a fourth embodiment of the present disclosure.

FIG. 35 is a diagram that illustrates another exemplary configuration of the light source according to the fourth embodiment of the present disclosure.

FIG. 36 is a diagram that illustrates an exemplary control of each laser element according to the light source controller of the fourth embodiment of the present disclosure.

FIG. 37 is a diagram that illustrates an exemplary configuration of a waveguide type optical multiplexer according to the modified third example of the third and fourth embodiments of the present disclosure.

### DETAILED DESCRIPTION

Embodiments of the present disclosure will be described in detail and examples of the embodiments will be illustrated in the accompanying drawings. The same or similar elements and the elements having same or similar functions are denoted by like reference numerals throughout the descriptions. The embodiments described herein with reference to the drawings are explanatory, which aim to illustrate the present disclosure, but shall not be construed to limit the present disclosure.

### First Embodiment

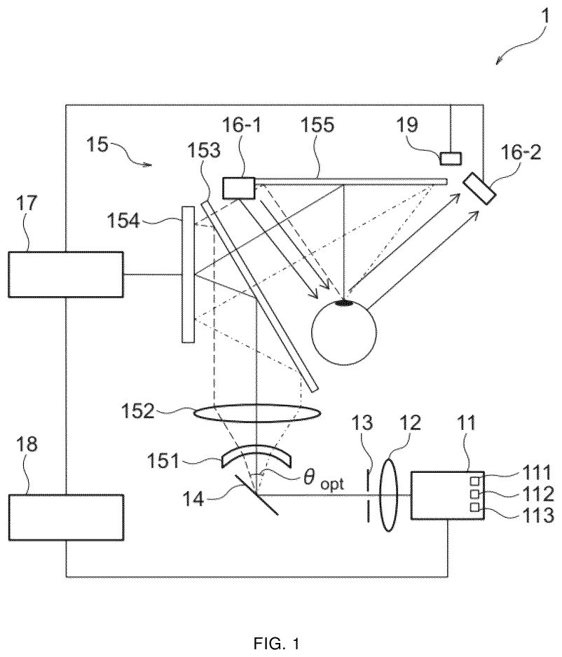

An image projection device according to the present disclosure will be described below. The image projection device according to the present disclosure is an eye tracking retinal projection type head-mount display that tracks a visual line direction of a user and projects an image to a user's retina. As shown in FIG. 1, the image projection device 1 according to the present disclosure comprises a light source 11, a collimate optical system 12, a light forming unit 13, a scanner 14, a projection optical system 15, a visual line direction detector 16, an optical system controller 17, a light source controller 18, and an angular velocity sensor 19.

The light source 11 irradiates a laser beam to the scanner 14. Specifically, as shown in FIG. 1, the light source 11 comprises at least one first laser element 111 that irradiates red light (i.e. a first color), at least one second laser element 112 that irradiates green light (i.e. a second color), and at least one third laser element 113 that irradiates blue light (i.e. a third color). In the present embodiment, the light source 11 comprises one of each of the first laser element 111, the second laser element 112, and the third laser element 113. The light source 111 multiplexes the RGB laser beam irradiated from each of the first laser element 111, the second laser element 112, and the third laser element 113, and irradiates to the scanner 14. A wavelength of the first laser element may be 650 nm, a wavelength of the second laser element may be 520 nm, and a wavelength of the third laser element may be 450 nm. The image projection device 1 may expand a color range by configuring each wavelength of the first laser element 111, the second laser element 112, and the third laser element 113 to have be the abovementioned values. Likewise, since a retina projection method which is the image projection device according to the present disclosure does not require optical output power, the optimal wavelength is easily selected as described above in order to expand a color range.

Also, in the light source 11 according to the present embodiment, each of the first laser element 111, the second laser element 112, and the third laser element 113 may be a Vertical Cavity Surface Emitting Laser (VCSEL) element. The first laser element 111 being the VCSEL element has a first active layer that generates light. The first active layer includes Aluminum Gallium Indium Phosphide (AlGaInP). The second laser element 112 being the VCSEL element has a second active layer that generates light. The second active layer includes Indium Gallium Nitride (InGaN). Furthermore, the third laser element 113 being the VCSEL element has a third active layer that generates light. The third active layer includes InGaN, equivalent to the second active layer. The VCSEL element which especially has a highly reflective Distributed Bragg Reflector (DBR) structure is largely effective in expanding a color range since a desired wavelength may be selected and a wavelength does not change.

Each concrete structure of the first laser element 111, the second laser element 112, and the third laser element 113 according to the present embodiment refers to, for example, the following non-patent literatures, non-patent literature 1 [Kenichi Terao et al (2021). PROCEEDINGS OF THE INTERNATIONAL DISPLAY WORKSHOPS, VOL. 28], and non-patent literature 2 [Tatsushi Hamaguchi et al (2018). Lateral optical confinement of GaN-based VCSEL using an atomically smooth monolithic curved mirror. Scientific Reports]. The first laser element 111, the second laser element 112, and the third laser element 113 according to the present may have various structures.

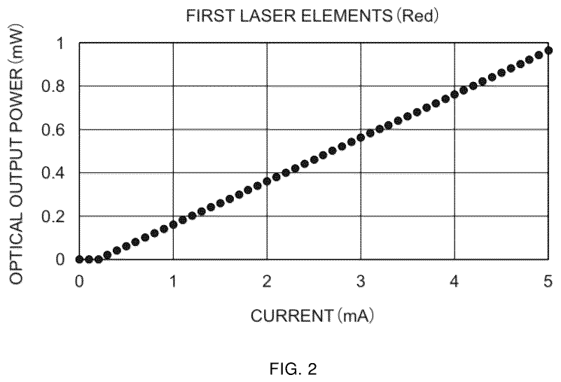

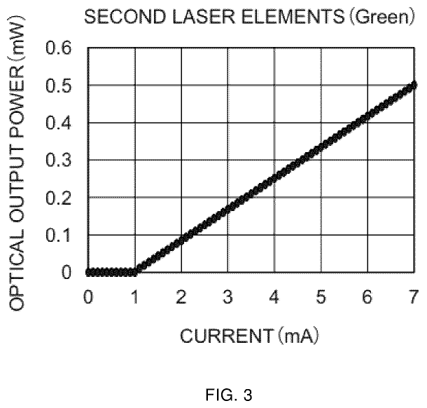

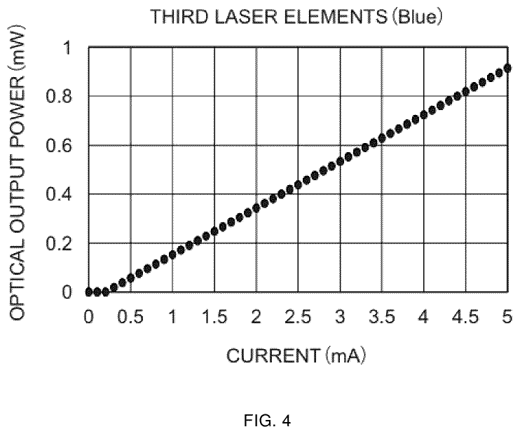

Each optical output power of the first laser element 111, the second laser element 112, and the third laser element 113 according to the present embodiment is less than or equal to 1 mW as shown in FIGS. 2 to 4. Each optical output power of the first laser element 111, the second laser element 112, and the third laser element 113 may be suppressed since the image projection device 1 according to the present disclosure is a retinal projection type display that directly projects an image to the user's retina.

Likewise, a threshold current, which is a minimum amount of current necessary to emit each laser beam of the first laser element 111, the second laser element 112, and the third laser element 113, is preferably less than or equal to 6 mA, more preferably less than or equal to 3 mA or even more preferably less than or equal to 1 mA as shown in FIGS. 2 to 4, by changing material composition of the highly reflective DBR structure or increasing a reflection index of the highly reflective DBR structure, and changing a mirror shape of the highly reflective DBR structure, etc. As such, the threshold current, which is the minimum amount of current necessary to emit laser beam may be suppressed, because each optical output power of the first laser element 111, the second laser element 112, and the third laser element 113 may be suppressed since the image projection device 1 according to the present disclosure is a retinal projection type display that directly projects an image to the user's retina.

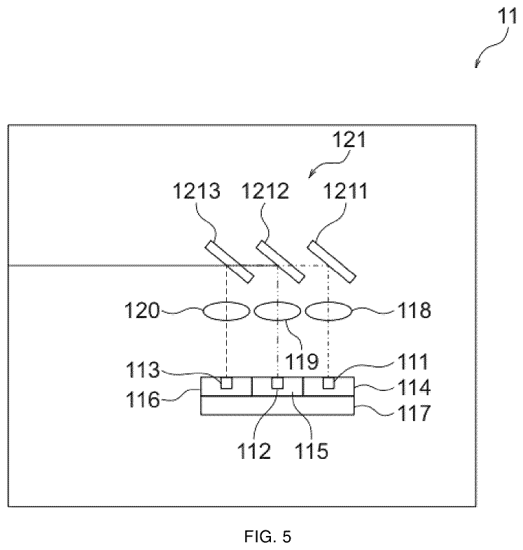

Next, a detailed configuration of the light source 11 will be described. The light source 11 the present embodiment comprises the first laser element 111, the second laser element 112, and the third laser element 113, a first semiconductor chip 114, a second semiconductor chip 115, a third semiconductor chip 116, a drive circuit 117, a first collimate lens 118, a second collimate lens 119, a third collimate lens 120, and a multiplexing optical system 121 as shown in FIG. 5. Each of the first laser element 111, the second laser element 112, and the third laser element 113 may include a semiconductor substrate. In this case, it is preferable that the semiconductor substrate, for example, is disposed between a first highly reflective DBR and a second highly reflective DBR which sandwich active layer. The semiconductor substrate is not limited to such configuration, and may be disposed on the outside of either of the first highly reflective DBR and the second highly reflective DBR.

The first semiconductor chip 114 comprises the first laser element 111. In the present embodiment, the first semiconductor chip 114 is disposed on the drive circuit 117 as shown in FIG. 5.

The second semiconductor chip 115 comprises the second laser element 112. In the present embodiment, the second semiconductor chip 115 is disposed on the drive circuit 117 as shown in FIG. 5.

The third semiconductor chip 116 comprises the third laser element 113. In the present embodiment, the third semiconductor chip 116 is disposed on the drive circuit 117 as shown in FIG. 5.

As described above, a wiring connecting each semiconductor chip and the drive circuit 117 may be shortened by disposing each semiconductor chip which comprises each laser element on the drive circuit 117. As a result, high frequency characteristics and high gradation characteristics may be achieved.

The drive circuit 117 is a circuit that drives each of the first laser element 111, the second laser element 112, and the third laser element 113. As shown in FIG. 5, the drive circuit 117 is disposed on an opposite side of an emitting direction of each of the first laser element 111, the second laser element 112, and the third laser element 113. Note that, one drive circuit 117 is provided for the first laser element 111, the second laser element 112, and the third laser element 113, but the drive circuit 117 may be provided for the first laser element 111, the second laser element 112, and the third laser element 113 respectively.

The first collimate lens 118 disposed between the first laser element 111 and the multiplexing optical system 121, collimates the laser beam emitted from the first laser element 111.

The second collimate lens 119 disposed between the second laser element 112 and the multiplexing optical system 121, collimates the laser beam emitted from the second laser element 112.

The third collimate lens 120 disposed between the third laser element 113 and the multiplexing optical system 121, collimates the laser beam emitted from the third laser element 113.

The first collimate lens 118, the second collimate lens 119, and the third collimate lens 120 collimates laser beam respectively emitted from the first laser element 111, the second laser element 112, and the third laser element 113, such that the laser beams emitted from each of the first laser element 111, the second laser element 112, and the third laser element 113 have a same beam diameter.

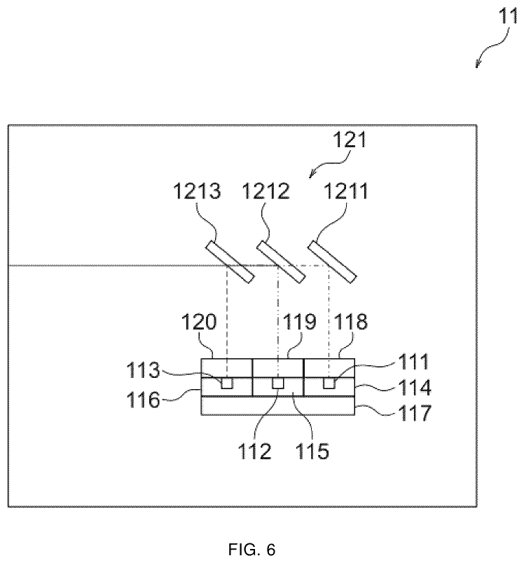

In the present embodiment, as shown in FIG. 6, the first collimate lens 118, the second collimate lens 119, and the third collimate lens 120 may be diffractive lenses instead of ordinary bulk lenses shown in FIG. 5 to reduce thickness.

Diffractive lens is also called as a meta-lens. If the first collimate lens 118, the second collimate lens 119, and the third collimate lens 120 are meta lenses, the meta lenses are disposed to contact each emitting surface of the first laser element 111, the second laser element 112, and the third laser element 113 as shown in FIG. 6. As such, by using meta lenses for the first collimate lens 118, the second collimate lens 119, and the third collimate lens 120, the first collimate lens 118, the second collimate lens 119, and the third collimate lens 120 may be thinned and miniaturized, and may make the beam diameter of the laser beam output from each laser element small since this contacts the emitting surface of each laser element. Furthermore, in the present embodiment, the meta lens becomes an effective collimate lens for thinning and miniaturization since each laser element is the VCSEL element which has little wavelength variation.

The multiplexing optical system 121 multiplexes laser beam emitted from each of the first laser element 111, the second laser element 112, and the third laser element 113 to emit a multiplexed beam. In the present embodiment, the multiplexing optical system 121 comprises a first reflecting optical system 1211, a second reflecting optical system 1212, and a third reflecting optical system 1213 as shown in FIG. 5.

The first reflecting optical system 1211 is disposed to reflect the laser beam emitted from the first laser element 111 to the scanner 14 side; the second reflecting optical system 1212 is disposed to reflect the laser beam emitted from the second laser element 112 to the scanner 14 side; and the third reflecting optical system 1213 is disposed to reflect the laser beam emitted from the third laser element 113 to the scanner 14 side. The first reflecting optical system 1211, the second reflecting optical system 1212, and the third reflecting optical system 1213 are also disposed such that the laser beam reflected from each of the first reflecting optical system 1211, the second reflecting optical system 1212, and the third reflecting optical system 1213 multiplex on a same optical axis.

In the present embodiment, the first reflecting optical system 1211, the second reflecting optical system 1212, and the third reflecting optical system 1213 may be an optical system having a dichroic function. In this case, it is desirable to match a polarization direction of a beam of each wavelength. Likewise, a beam of each wavelength may be adjusted to change a direction of a linearly polarized light and change the linearly polarized light into a circularly polarized light by using a λ/2 plate or a λ/4 plate (not illustrated).

The collimate optical system 12 collimates the laser beam emitted from the light source 11 and emits the collimated laser beam to the scanner 14 side. As shown in FIG. 1, the collimate optical system 12 is disposed between the light source 11 and the scanner 14. Although the collimate optical system 12 has one lens in the example shown in FIG. 1, the configuration of the collimate optical system 12 is not limited to such. That is to say, the configuration of the collimate optical system 12 is arbitrary, and may comprise a plurality of lenses or may comprise a single lens such as a SELFOC lens.

The light forming unit 13 forms the laser beam emitted from the light source 13. The light forming unit 13 may be configured by a mask, an optical filter (a neutral density (ND) filter, a gaussian beam filter or a rectangular beam filter etc.), or a combination thereof. As shown in FIG. 1, the light forming unit 13 is disposed between the collimate optical system 12 and the scanner 14. In the example shown in FIG. 1, the light forming unit 13 is configured by the mask having an aperture. Note that if the light forming unit 13 is configured with an optical ND filter, the optical ND filter not only may remove naturally generated light (for instance, a light-emitting diode (LED) light), but also may evade an effect of kinks that could arise when the first, second, and third laser elements are driven with a relatively high current, to evade driving with a micro output current very close to a threshold current, and project high resolution images to the user's retina. The gaussian beam filter may reduce side lobes of beams finally condensed on the user's retina and generate high-resolution images. On the other hand, the rectangular beam filter may reduce a beam diameter by generating a side lobe and increase resolution. As such, the image projection device 1 according to the present disclosure comprises the light forming unit 13 forming a desired beam.

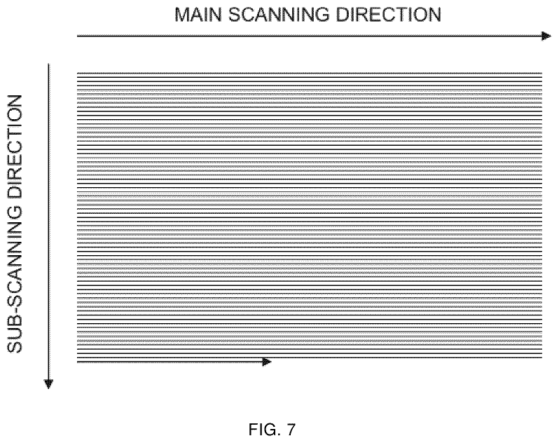

The scanner 14 disposed between the light forming unit 13 and the projection optical system 15 scans the laser beam emitted from the light source 11 two-dimensionally. The scanner 14 may be a scanning mirror such as a Micro Electric Mechanical System (MEMS) mirror. The scanner 14 may perform scanning with resonant operation for main scanning and non-resonant operation for sub-scanning. In the present embodiment, the scanner 14 scans with a luster scanning method using resonance to the laser beam emitted from the light source 11 in a main scanning direction as shown in FIG. 7. The high-quality image may be projected to the user's retina by the scanner scanning with the luster scanning method.

A relationship between the scanner 14 and the resolution of the image may be represented by the following equation.

$$N = ( θ opt * D ) / ( 1.1 * λ ) \qquad ( 1 )$$

In equation (1), θopt is an optical swing angle to scan the laser beam emitted from the light source 11 two-dimensionally (hereinafter the same applies). D is a diameter of the scanner 14 (hereinafter the same applies). λ is the wavelength of the laser beam (hereinafter the same applies). Thus, θopt*D should be enlarged in order to project images with higher resolution to the user's retina.

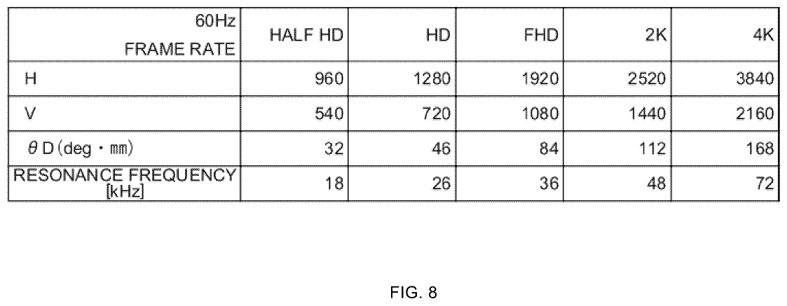

Such scanner 14, as shown in FIG. 8, requires a resonance frequency of 72 kHz with θopt*D of 168 [deg·mm] when an image is projected with a framerate of 60 Hz and resolution of 4K to the user's retina.

The projection optical system 15 is an optical system that projects images by irradiating the laser beam scanned by the scanner 14 to the user's retina. As shown in FIG. 1, the projection optical system 15 according to the present embodiment comprises a first lens 151, a second lens 152, a first reflection mirror 153, a tilt mirror module 154 having a tilt mirror as a second reflection mirror, and a third reflection mirror 155.

The first lens 151 and the second lens 152 disposed between the scanner 14 and the first reflection mirror 153 converts the laser beam scanned by the scanner 14 into parallel beam and emits to the first reflection mirror 153. Although the projection optical system 15 in the present embodiment converts the laser beam scanned by the scanner 14 into parallel beam by the first lens 151 and the second lens 152, the projection optical system may convert into parallel beam by having more than three lenses.

The first reflection mirror 153 disposed between the second lens 152 and the tilt mirror module 154 reflects the laser beam emitted from the second lens 152 to the tilt mirror module 154. Likewise, the first reflection mirror 153 according to the present embodiment lets the laser beam reflected by the tilt mirror module 154 pass through. That is to say, the first reflection mirror 153 in the example shown in FIG. 1 may be a half mirror.

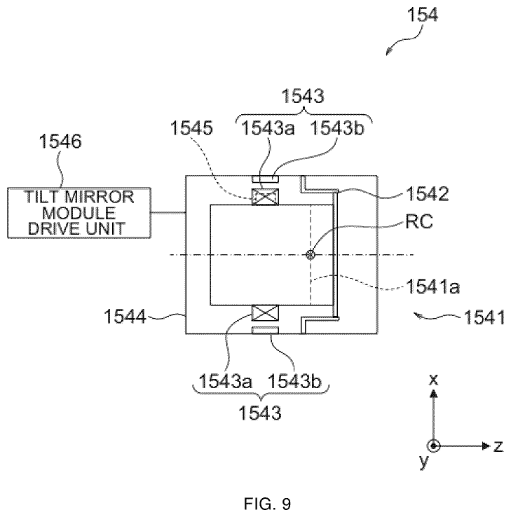

The tilt mirror module 154 disposed between the first reflection mirror 153 and the third reflection mirror reflects the laser beam reflected by the first reflection mirror 153 to the third reflection mirror 155. The tilt mirror module 154 is controlled by the optical system controller 17 based on the user's visual line direction detected by the visual line direction detector 16 and/or an angular velocity of image projection device 1 detected by the angular velocity sensor 19 such that the laser beam reflected by the tilt mirror module 154 is projected to the user's retina. As shown in FIG. 9, the tilt mirror module 154 comprises a movable body 1541, a gimbal mechanism 1542, a magnetic drive mechanism 1543, a fixed body 1544, a Hall sensor 1545, and a tilt mirror module drive mechanism 1546.

The movable body 1541 comprises the tilt mirror 1541a, which is the second reflection mirror that reflects the laser beam reflected by the first reflection mirror 153 to the third reflection mirror 155. The movable body 1541 is supported relative to the fixed body 1544 via the gimbal mechanism 1542 such that the tilt mirror 1541a oscillates around a center of rotation RC.

The gimbal mechanism 1542, for example, is configured by a metal leaf spring. The gimbal mechanism 1542 supports the movable body 1541 relative to the fixed body 1544 such that the tilt mirror 1541a oscillates around a center of rotation RC. In the example shown in FIG. 9, the gimbal mechanism 1542 supports the movable body 1541 such that the tilt mirror 1541a oscillates around a center of rotation RC in an X-axis and a Y-axis relative to the fixed body 1544.

The magnetic drive mechanism 1543 generates a magnetic driving force between the movable body 1541 and the fixed body 1544 that displaces the movable body 1541 relative to the fixed body 1544. The magnetic drive mechanism 1543 may comprise a coil 1543a and a magnet 1543b as shown in FIG. 9. In the example shown in FIG. 9, the coil 1543a is provided on the movable body 1541, the magnet 1543b is provided on the fixed body 1544, and the coil 1543a and the magnet 1543b are provided facing each other.

The fixed body 1544 is provided in an angularly modifiable manner around the X-axis and the Y-axis. The tilt mirror comprised by the movable body 1541 may irradiate the laser beam and project the image to the user's retina based on the user's visual line direction by having the fixed body 1544 modify the angle around the X-axis and the Y-axis.

The Hall sensor 1545 detects a tilt of the movable body 1541. The Hall sensor 1545 is provided near the magnet 1543b and on the movable body 1541. In the example shown in FIG. 9, the Hall sensor 1545 is provided inside the coil 1543a. By outputting the tilt of the movable body 1541 detected by the Hall sensor 1545 to the optical system controller 17, an angle of a mirror reflection surface of the tilt mirror 1541a may be controlled with high precision and responsiveness which has a sufficient frequency characteristics.

The tilt mirror module drive mechanism 1546 is a drive mechanism that modifies the angle of the tilt mirror 1541a based on the visual line direction detected by the visual line direction detector 16. For instance, the tilt mirror module drive mechanism 1546 is configured by a magnetic circuit, a piezo element or a motor etc. as a drive source as described above. Specifically, the tilt mirror module drive mechanism 1546 matches the eye tracking retinal projection method, since the tilt mirror method configured by the magnet circuit of a gimbal method may obtain superior frequency characteristics and may be miniaturized.

The third reflection mirror 155 disposed between the tilt mirror module 154 and the user's retina, reflects the laser beam reflected from the tilt mirror module 154 to the user's retina. The third reflection mirror may be a holographic optical system or a free-form surface mirror etc.

The visual line direction detector 16 comprises an irradiator 16-1 and a visual line position detector 16-2, where the irradiator 16-1 irradiates beam to the user's eye and the visual line position detector 16-2 detects the user's visual line direction for which the image is projected. The irradiator 16-1 refers to the laser element such as VCSEL or LED for low power consumption. The visual line position detector 16-2 is a detection sensor that detects user's visual line position. The visual line direction detector 16 outputs information related to the detected visual line direction to the optical system controller 17 or the light source controller 18. The visual line direction detector 16 may be an eye tracking camera etc.

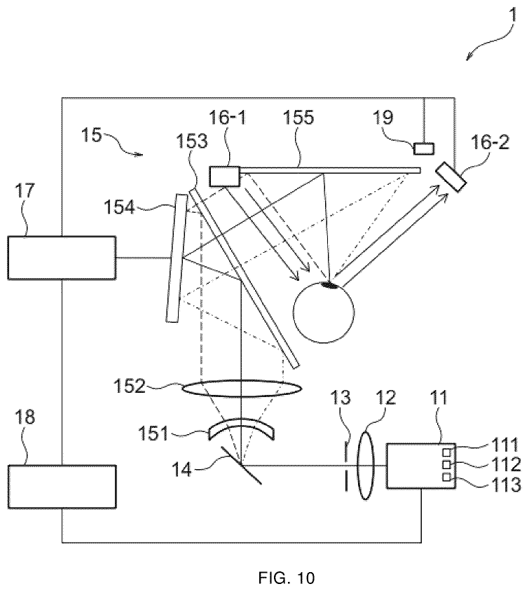

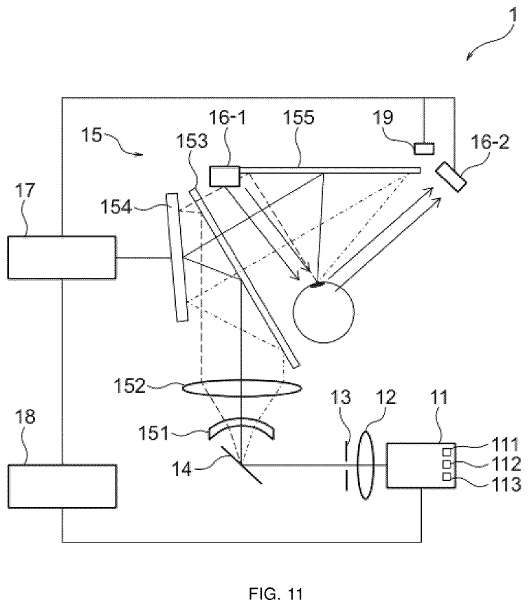

The optical system controller 17 controls the projection optical system 15 based on the visual line direction detected by the visual line direction detector 16. Specifically, as shown in FIGS. 10 and 11, the optical system controller 17 irradiates the laser beam and projects images to the user's retina by controlling the tilt mirror module drive mechanism 1546 of the tilt mirror module 154, based on the visual line direction detected by the visual line direction detector 16.

Likewise, the optical system controller 17 may control the magnetic drive mechanism 1543 of the tilt mirror module 154 based on a detection result of the angular velocity sensor 19 and the visual line direction detector 16. If the angular velocity sensor 19 detects angular velocity of the image projection device 1, the optical system controller 17 supplies a drive current to the coil 1543a to cancel out the tilt by a micro vibration on the tilt mirror 1541a based on the detection result of the angular velocity sensor 19. By such, even when vibration is applied to the tilt mirror, the image may be projected to the retina according to the user's visual line direction since the tilt mirror 1541a may oscillate around a center of rotation RC. As a result, an eye box may be widened by controlling the tilt mirror 1541a based on the detection result of the visual line direction detector 16.

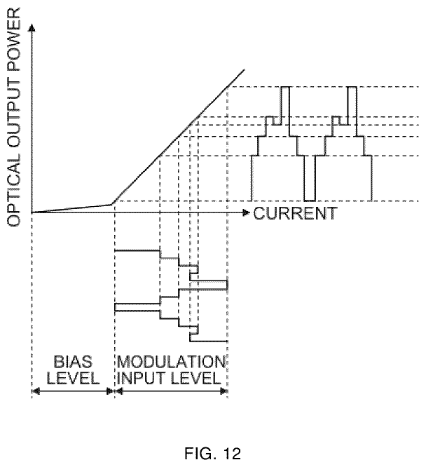

The light source controller 18 controls the light source 11 to control the laser beam emitted from the light source 11. Specifically, when image data is input, the light source controller 18 controls each of at least one first laser element 111, at least one second laser element 112, and at least one third laser element 113 such that the image based on the input image data is projected to the user's retina. More specifically, the light source controller 18 controls a modulation frequency of each of the at least one first laser element 111, at least one second laser element 112, and at least one third laser element 113 such that the image based on the input image data is projected to the user's retina. Further specifically, the light source controller 18 outputs an input signal based on the input image data to the light source 11 as shown in FIG. 12. The light source 11 then inputs current for driving each laser element based on the input signal to each laser element, performs linear modulation, irradiates each laser beam, changes a gradation, and displays the image.

Likewise, the light source controller 18 controls the resolution of the image projected to the user's retina based on the visual line direction detected by the visual line direction detector 16. Specifically, the light source controller 18 may change a resolution by changing the modulation frequency. More Specifically, the light source controller 18 may control the light source 11 such that the resolution of the image outside a predetermined area for the image projected in the user's visual line direction is lower than the resolution of the image within the predetermined area. More specifically, the light source controller 18 may control the input signal to the light source 11 such that the resolution of the image in the area outside the visual line direction is lower than the resolution of the image in the area of the visual line direction based on the visual line direction detected by the visual line direction detector 16, and control the modulation frequency of the light source 11. As such, the image projection device 1 may mitigate a load of image data processing and reduce power consumption by raising only the resolution of the image of the area projected to the user's visual line direction such that the resolution of the image outside the predetermined area for the image projected in the user's visual line direction is lower than the resolution of the image within the predetermined area.

Likewise, the light source controller 18 may control such that the gradation of linear modulation becomes correct gradation by finely adjusting an output of each of the first laser element 111, the second laser element 112, and the third laser element 113 based on a detection result of a photodetector that detects a radiation intensity of the laser beam emitted from the light source 11. Specifically, the light source 18 controls the gradation of linear modulation of each of the first laser element 111, the second laser element 112, and the third laser element 113 to be correct by generating a correction current to drive the first laser element 111, the second laser element 112, and the third laser element 113 based on the detection result of the photodetector.

Furthermore, the light source controller 18 may control the gradation of linear modulation of each of the first laser element 111, the second laser element 112, and the third laser element 113 to be correct based on a detection result of a temperature sensor that measures each temperature of the first laser element 111, the second laser element 112, and the third laser element 113. Specifically, the light source controller 18 controls the gradation of linear modulation of each of the first laser element 111, the second laser element 112, and the third laser element 113 to be correct by generating the correction current to drive the first laser element 111, the second laser element 112, and the third laser element 113 based on the detection result of the temperature sensor.

Note that the method of reducing the resolution of the image outside the predetermined area for the image projected in the user's visual line direction lower than the resolution of the image within the predetermined area is not limited to be performed by controlling the modulation frequency of each of the light source. The image projection device 1 may comprise an image processing apparatus (not illustrated). The image processing apparatus performs image processing such that the resolution of image data outside the area corresponding to the visual line direction becomes lower than the resolution of image data within the area corresponding to the visual line direction based on the visual line direction detected by the visual line direction detector 16. Then, by inputting the image processed image data to the light source controller 18, the light source controller 18 may control the light source 11 such that the resolution of the image outside a predetermined area for the image projected in the user's visual line direction is lower than the resolution of the image within the predetermined area.

As described above, the image projection device 1 according to the present embodiment may suppress the output of the laser beam, since the image projection device 1 is a device of the eye tracking retinal projection type that detects the user's visual line direction and projects the image to the user's retina based on the detected visual line direction, which may be driven with low power consumption while realizing a stable operation without changing the threshold current value arising from self-heating, since the image projection device 1 may be operated with low threshold current. Also, the load of image processing may be mitigated by reducing nearby resolutions, which may also decrease the power consumption of image processing.

Likewise, the wavelength hardly changes even when the drive current value is modified in the first embodiment described above, which may realize a high color reproducibility since the first laser element 111, the second laser element 112, and the third laser element 113 are VCSEL elements.

Likewise, in the first embodiment described above, since the drive circuit 117 is disposed on an opposite side to an emitting direction of each of the first laser element 111, the second laser element 112, and the third laser element 113, the capacitance may be made small and the linear modulation of the first laser element 111, the second laser element 112, and the third laser element 113 fast, and an output stability of each laser element during low gradation realized and high brightness of the image projected to the user's retina during high gradation realized, intermingling with high speed to realize not only a 10-bit gradation but also a 16-bit gradation. Further, reducing the nearby resolution may decrease power consumption, which allows the low power consumption of the image projection device 1 even when 16-bit gradation is realized.

Note that, in the first embodiment described above, each of the first laser element 111, the second laser element 112, and the third laser element 113 were configured by VCSEL elements, but each of the first laser element 111, the second laser element 112, and the third laser element 113 may be configured by an edge-emitting laser element. Even when each of the first laser element 111, the second laser element 112, and the third laser element 113 is configured by the edge-emitting laser elements, the output of the laser beam may be suppressed since the image projection device 1 is the device of the eye tracking retinal projection type that detects the user's visual line direction and projects the image to the user's retina based on the detected visual line direction, which may be driven with low power consumption while realizing a stable operation without changing the threshold current value arising from self-heating, since the image projection device 1 may be operated with low threshold current.

### Second Embodiment

In the first embodiment described above, the light source 11 according to the image projection device 1 was configured with one of each of the first laser element 111, the second laser element 112, and the third laser element 113, but the number of each laser element is not limited to being one. In a second embodiment, the light source 11 according to the image projection device 1 may comprise a plurality of each of the first laser element 111, the second laser element 112, and the third laser element 113. Hereinafter, parts that differ from that of the first embodiment described above will be described.

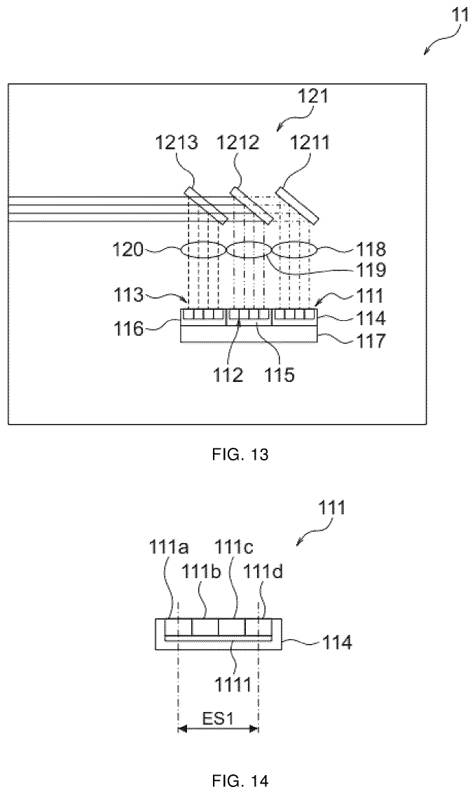

As shown in FIG. 13, the light source 11 according to the present embodiment comprises the plurality of first laser elements 111, the plurality of second laser elements 112, the plurality of third laser elements 113, the first semiconductor chip 114, the second semiconductor chip 115, the third semiconductor chip 116, the drive circuit 117, the first collimate lens 118, the second collimate lens 119, and the third collimate lens 120, and the multiplexing optical system 121. Note that the configuration of the multiplexing optical system 121 is similar to that of the first embodiment described above, and description will be omitted. Each of the first laser element 111, the second laser element 112, and the third laser element 113 may include a semiconductor substrate. In this case, it is preferable that the semiconductor substrate, for example, is disposed between the first highly reflective DBR and the second highly reflective DBR which sandwich the active layer. The semiconductor substrate is not limited to such configuration, and may be disposed on the outside of either of the first highly reflective DBR and the second highly reflective DBR.

As shown in FIGS. 13 and 14, the plurality of first laser elements 111 comprises the first laser elements 111a˜111d as a red first laser element group which the active layer is AlGaInP. The plurality of first laser elements 111 are integrated on the same first semiconductor substrate 1111. Likewise, as shown in FIGS. 13 and 14, the plurality of first laser elements 111 are arranged on the first semiconductor substrate 1111 in one direction, separated by a predetermined space. The emitter size ES1, which is the distance between the centers of light-emitting part of the first laser element 111a and the first laser element 111d separated away the furthest among the first laser elements 111a˜111d is large, the diameter D of MEMS should be large. As a result, it is possible to increase the resonance frequency, and the resolution decreases. On the other hand, if the emitter size ES1 is small, the optical output power of laser elements becomes unstable due to the influence of the heat generation of adjacent element, and it becomes difficult to manufacture the first laser element group. Especially, using the laser element with a small oscillation threshold decreases thermal interference on each other, since a VCSEL method easily realizes the oscillation threshold to be less than or equal to 1 mA in comparison to ordinary Laser Diode (LD), and the retinal projection method does not require optical output power. Thus, it becomes possible to reduce the emitter size, and the emitter size ES1 according to the present embodiment, for instance, evades the thermal interference between neighboring beams, provides beam expander in the optical system of the light source 11 and is less than or equal to 90 μm to make a small optical system of the light source 11, preferably less than or equal to 30 μm to achieve miniaturization of the optical system of the light source 11, and more preferably less than or equal to 5 μm to greatly increase the resolution, such as up to 4K, and achieve extreme miniaturization of the optical system of the light source 11 (hereinafter the same applies).

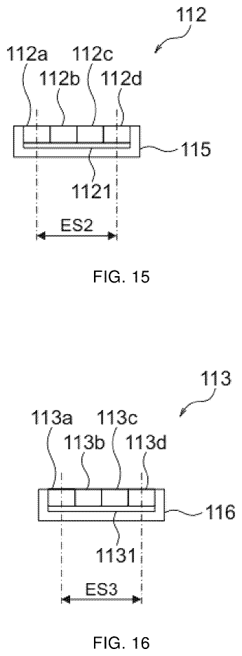

As shown in FIGS. 13 and 15, the plurality of second laser elements 112 comprises the second laser elements 112a˜112d as a green second laser element group which the active layer is InGaN. The plurality of second laser elements 112 are integrated on the same second semiconductor substrate 1121. Likewise, as shown in FIGS. 13 and 15, the plurality of second laser elements 112 are arranged on the second semiconductor substrate 1121 in one direction, separated by a predetermined space. The emitter size ES2, which is the distance between the centers of light-emitting part of the second laser element 112a and the second laser element 112d separated away the furthest among the second laser elements 112a˜112d may be, less than or equal to 90 μm, preferably less than or equal to 30 μm, and more preferably less than or equal to 5 μm.

As shown in FIGS. 13 and 16, the plurality of third laser elements 113 comprises the third laser elements 113a˜113d as a blue third laser element group which the active layer is InGaN. The plurality of third laser elements 113 are integrated on the same third semiconductor substrate 1131. Likewise, as shown in FIGS. 13 and 16, the plurality of third laser elements 113 are arranged on the third semiconductor substrate 1131 in one direction, separated by a predetermined space. The emitter size ES3, which is the distance between the centers of light-emitting part of the third laser element 113a and the third laser element 113d separated away the furthest among the third laser elements 113a˜113d may be, less than or equal to 90 μm, preferably less than or equal to 30 μm, and more preferably less than or equal to 5 μm.

The plurality of first laser elements 111, the plurality of second laser elements 112, and the plurality of third laser elements 113 are disposed such that the emitter sizes ES1˜ES3 are the same.

Note that, the example shown in FIG. 13 comprises four of each of the plurality of first laser elements 111, the plurality of second laser elements 112, and the plurality of third laser elements 113, but the number of the plurality of first laser elements 111, the plurality of second laser elements 112, and the plurality of third laser elements 113 is arbitrary, and may be less than or equal to 3 or less than or equal to 6.

The first semiconductor chip 114 comprises the plurality of first laser elements 111. In the present embodiment, the first semiconductor chip 114 is disposed on the drive circuit 117 as shown in FIG. 13.

The second semiconductor chip 115 comprises the plurality of second laser elements 112. In the present embodiment, the second semiconductor chip 115 is disposed on the drive circuit 117 as shown in FIG. 13.

The third semiconductor chip 116 comprises the plurality of third laser elements 113. In the present embodiment, the third semiconductor chip 116 is disposed on the drive circuit 117 as shown in FIG. 13.

The drive circuit 117 is a circuit that drives each of the plurality of first laser elements 111, the plurality of second laser elements 112, and the plurality of third laser elements 113. As shown in FIG. 13, the drive circuit 117 is disposed on an opposite side of an emitting direction of each of the plurality of the first laser element 111, the plurality of the second laser element 112, and the plurality of the third laser element 113.

The first collimate lens 118 disposed between the plurality of first laser elements 111 and the multiplexing optical system 121 collimates a plurality of laser beams emitted from the plurality of first laser elements 111. That is to say, the light source 11 according to the present element comprises one first collimate lens 118 for the plurality of first laser elements 111, as shown in FIG. 13.

The second collimate lens 119 disposed between the plurality of second laser elements 112 and the multiplexing optical system 121 collimates a plurality of laser beams emitted from the plurality of second laser elements 112. That is to say, the light source 11 according to the present element comprises one second collimate lens 119 for the plurality of second laser elements 112, as shown in FIG. 13.

The third collimate lens 120 disposed between the plurality of third laser elements 113 and the multiplexing optical system 121 collimates a plurality of laser beams emitted from the plurality of third laser elements 113. That is to say, the light source 11 according to the present element comprises one third collimate lens 120 for the plurality of third laser elements 113, as shown in FIG. 13.

Note that, in the present embodiment, one of each of the first collimate lens 118, the second collimate lens 119, and the third collimate lens 120 was provided for the plurality of first laser elements 111, the plurality of second laser elements 112, and the plurality of third laser elements 113, but embodiments are not limited to this. One of each of the first collimate lens 118, the second collimate lens 119, and the third collimate lens 120 may be provided for each laser element of the plurality of first laser elements 111, the plurality of second laser elements 112, and the plurality of third laser elements 113.

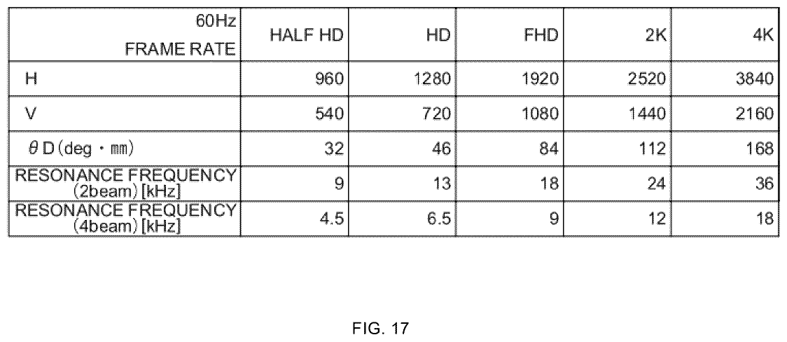

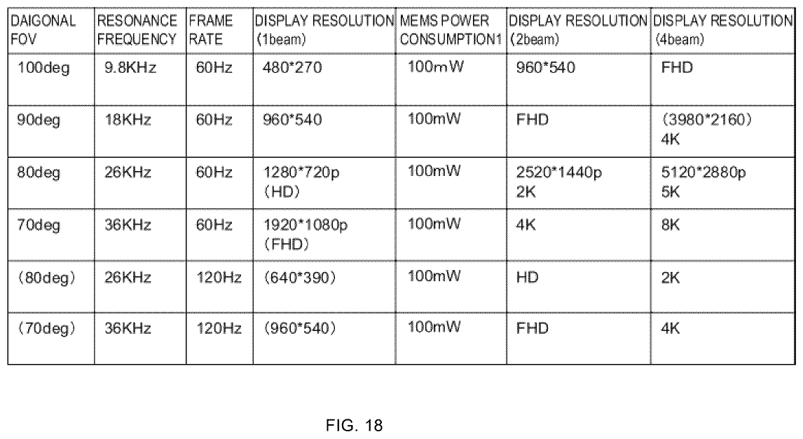

The scanner 14 according to the present embodiment scans the laser beam by reducing a resonance frequency in response to the number of each of the first laser elements 111, the second laser elements 112, and the third laser elements 113 enlarging the optical swing angle θopt and enlarging θopt*D in formula (1). As a result, it is possible to make the resolution of the image projected to the user's retina higher. Specifically, as shown in FIGS. 8 and 17, when scanning the laser beam emitted from each of the plurality of first laser elements 111, the plurality of second laser elements 112, and the plurality of third laser elements 113, the scanner 14 compares this to when scanning the laser beam emitted from the first laser element 111, the second laser element 112, and the third laser element 113, the resonance frequency of the MEMS may be reduced, θopt*D in formula (1) enlarged, and the resolution of the image projected to the user's retina increased. That is to say, when scanning the laser beam emitted from each of the plurality of first laser elements 111, the plurality of second laser elements 112, and the plurality of third laser elements 113, and when the resolution of the image projected to the user's retina is made the same, as shown in FIG. 18, the scanner 14 may reduce the resonance frequency in the main scanning direction in response to the number of laser elements, enlarge θopt*D in formula (1) to increase resolution, and reduce the modulation frequency of the laser elements. Likewise, since the light source 11 according to the present embodiment may scan the laser beam with the luster scanning method by using the light source for which each of the plurality of first laser elements 111, the plurality of second laser elements 112, and the plurality of third laser elements 113 are separated by the predetermined space, to reduce the resonance frequency in the main scanning direction, enlarge the optical swing angle θopt, and enlarge θopt*D in formula (1) as a result, the image is projected to the user's retina with a resolution higher than High Definition (HD), i.e. HD, FHD, 2K, and 4K resolution.

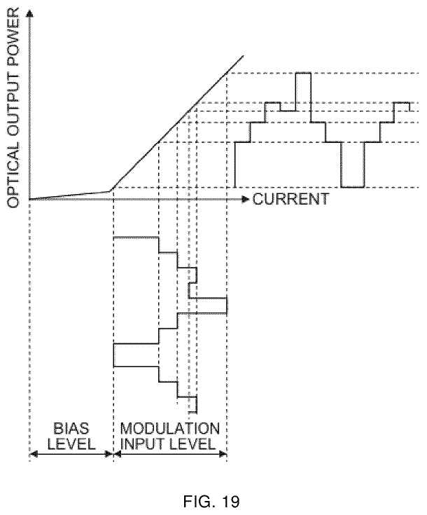

The light source controller 18 according to the present embodiment controls the light source 11 such that the modulation frequency of each of the plurality of first laser elements 111, the plurality of second laser elements 112, and the plurality of third laser elements 113 are reduced than the modulation frequency of each of the laser element when one first laser element 111, one second laser element 112, and one third laser element 113 are provided, in response to the number of each of the plurality of first laser elements 111, the plurality of second laser elements 112, and the plurality of third laser elements 113. In the case of equivalent resolution, for instance, in the case of projecting images with FHD resolution and 120 Hz framerate with one first laser element 111, one second laser element 112, and one third laser element 113, each of the first laser element 111, the second laser element 112, and the third laser element 113 is required to be controlled by the modulation frequency of 1920*1080*120=250 MHz; but in the case of projecting images with FHD resolution and 120 Hz framerate with four first laser elements 111, four second laser elements 112, and four third laser elements 113, 250 MHz/4=62.5 MHz is sufficient to control the four first laser elements 111, four second laser elements 112, and four third laser elements 113. That is, as shown in FIG. 19, in the case of equivalent resolution, the light source controller 18 reduces the modulation frequency of each of the input signal compared to that of FIG. 12, based on image data output to each laser element to comprise the plurality of first laser elements 111, the plurality of second laser elements 112, and the plurality of third laser elements 113. As a result, high gradation may be realized.

Likewise, the light source controller 18 may control such that the gradation of linear modulation becomes correct gradation by finely adjusting the output of each of the plurality of first laser elements 111, the plurality of second laser elements 112, and the plurality of third laser elements 113 based on the detection result of the photodetector that detects the radiation intensity of the laser beam emitted from the light source. Specifically, the light source controller 18 controls a gradation of linear modulation of each of the plurality of first laser elements 111, the plurality of second laser elements 112, and the plurality of third laser elements 113 by generating the correction current to drive the first laser element 111, the second laser element 112, and the third laser element 113 based on the detection result of the photodetector.

Furthermore, the light source controller 18 may control gradation of linear modulation of each of the plurality of first laser elements 111, the plurality of second laser elements 112, and the plurality of third laser elements 113 to be correct based on the detection result of the temperature sensor that measures the temperature of each of the plurality of first laser elements 111, the plurality of second laser elements 112, and the plurality of third laser elements 113. Specifically, the light source controller 18 controls a gradation of linear modulation of each of the plurality of first laser elements 111, the plurality of second laser elements 112, and the plurality of third laser elements 113 to be correct by generating the correction current to drive the first laser element 111, the second laser element 112, and the third laser element 113 based on the detection result of the temperature sensor.

As described above, by the light source in the image projection device 1 according to the present embodiment comprising the plurality of first laser elements 111, the plurality of second laser elements 112, and the plurality of third laser elements 113, the power consumption of each laser element per unit time may be reduced, a heat dissipation characteristic may be improved, and a change of oscillation threshold may be further suppressed. Likewise, the power consumption of a driver may also be decreased since the modulation frequency may be reduced.

Likewise, in the present embodiment, by the light source 11 comprising the plurality of first laser elements 111, the plurality of second laser elements 112, and the plurality of third laser elements 113, the scanner 14 may reduce the resonance frequency in main scanning direction and reduce the power consumption of the scanner 14.

Likewise, in the present embodiment, by the light source 11 comprising the plurality of first laser elements 111, the plurality of second laser elements 112, and the plurality of third laser elements 113, the image projection device 1 may reduce the resonance frequency in main scanning direction of the plurality of first laser elements 111, the plurality of second laser elements 112, and the plurality of third laser elements 113, enlarge θopt*D from enlarging θopt, and project to the user's retina with a high field of view (FOV). For this reason, the image projection device 1 may maintain reducing the resonance frequency in main scanning direction of the scanner 14 and the FOV projected to the user's retina and enlarge θopt*D so as to improve the resolution of the image projected to the user's retina.

Likewise, in the present embodiment, since the light source 11 comprises the plurality of first laser elements 111, the plurality of second laser elements 112, and the plurality of third laser elements 113, the image projection device 1 may reduce the resonance frequency in main scanning direction in response to the number of the first laser element 111, the second laser element 112, and the third laser element 113, enlarge θopt, enlarge θopt*D in formula (1) as a result, and scan the laser beam, high-resolution image may be projected to the user's retina. For this reason, since the resonance frequency in the main scanning direction is proportional to the product of the framerate and the vertical resolution, the image projection device 1 may maintain the resonance frequency in main scanning direction of the scanner 14 and the resolution of the image projected to the user's retina to improve the framerate in response to the number of the first laser element 111, the second laser element 112, and the third laser element 113.

Furthermore, in the present embodiment, since the light source controller 18 comprises the plurality of first laser elements 111, the plurality of second laser elements 112, and the plurality of third laser elements 113, the light source 18 controls the light source 11 such that the modulation frequency of each of the plurality of first laser elements 111, the plurality of second laser elements 112, and the plurality of third laser elements 113 is reduced than the modulation frequency of each of laser element, when one first laser element 111, one second laser element 112, and one third laser element 113 are provided. By such, the light source 11 may improve a controllability of linear modulation and increase the number of bit gradation for the image projected to the retina.

### Modified First Example of the Second Embodiment

In the second embodiment described above, since the light source 11 comprises the plurality of first laser elements 111, the plurality of second laser elements 112, and the plurality of third laser elements 113, the modulation speed of each laser element may be reduced, i.e. the modulation frequency may be reduced more than in the first embodiment. Likewise, the drive current of each laser element may be small because the image projection device 1 is the device that projects the image to the user's retina. Accordingly, precise gradation control in low gradation, a waveform distortion or an overshoot may be reduced by performing control of micro current and control of reducing the modulation speed while performing linear modulation. Accordingly, the gradation of the image may be increased and there may be more room for the laser output, which increases the brightness and allows precise control in high gradation. Thus, in the second embodiment described above, the light source controller 18 may arbitrarily control a gradation number of each of the plurality of first laser elements 111, the plurality of second laser elements 112, and the plurality of third laser elements 113 such that the gradation of the image projected to the user's retina becomes greater than or equal to 12-bit and less than or equal to 16-bit. Likewise, the light source controller 18 may control the gradation number of linear modulation of each of the plurality of first laser elements 111, the plurality of second laser elements 112, and the plurality of third laser elements 113 to project a High Dynamic Range (HDR) image to the user's retina such that the gradation of the image projected to the user's retina becomes greater than or equal to 12-bit and less than or equal to 16-bit. Especially, since the device is that of an eye tracking retinal projection method, it becomes possible to increase the gradation or resolution of the image information corresponding to the visual line direction, i.e. mitigating the load of image processing by decreasing the gradation and resolution outside the visual line direction.

### Modified Second Example of the Second Embodiment

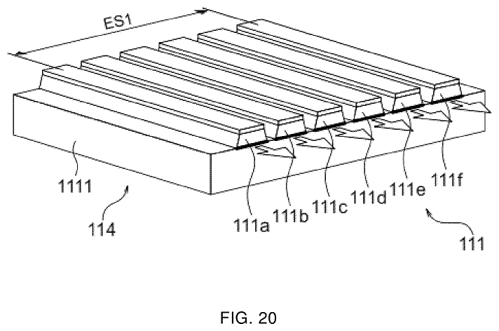

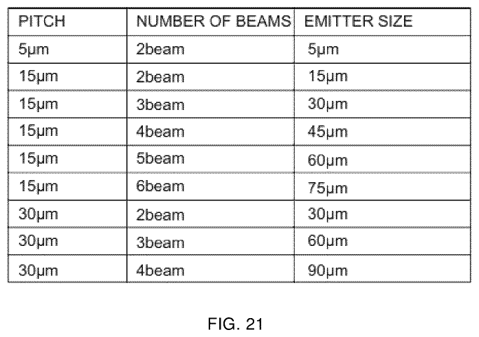

Likewise, although the plurality of first laser elements 111, the plurality of second laser elements 112, and the plurality of third laser elements 113 were configured with VCSEL elements in the second embodiment, the plurality of first laser elements 111, the plurality of second laser elements 112, and the plurality of third laser elements 113 may be configured with the edge-emitting laser elements. In the example shown in FIG. 20, the emitter size ES1 of the first laser elements 111a˜111h is the distance between the centers of light-emitting part of the first laser element 111a and the first laser element 111f. Likewise, similar to the emitter size ES1 of the first laser elements 111a˜111h, the emitter size ES2 of the second laser elements 112a˜112h is the distance between the centers of light-emitting part of the second laser element 112a and the second laser element 112f, and the emitter size ES3 of the third laser elements 113a˜113h is the distance between the centers of light-emitting part of the third laser element 113a and the third laser element 113f. Then, when the emitter size of one laser element is set to 1 μm as shown in FIG. 21, the emitter size for each pitch and each number of beams may be suppressed to less than or equal to 90 μm. Likewise, as shown in FIG. 21, the emitter size may be set to less than or equal to 30 μm, or less than or equal to 5 μm. accordingly, the scanner may be miniaturized and θopt*D enlarged, since the emitter size may be suppressed even when each laser element is configured by the edge-emitting laser element.

### Modified Third Example of the Second Embodiment

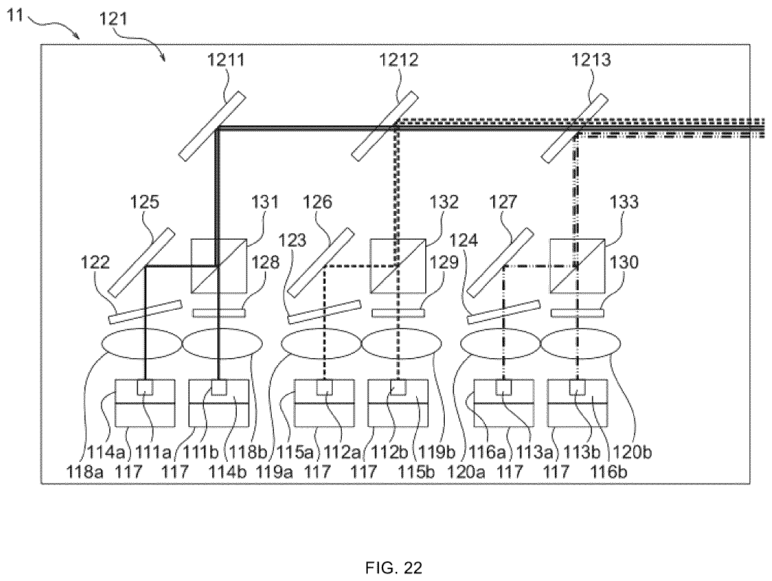

In the second embodiment described above, the image projection device 1 may comprise a beam shifter that shifts by an arbitrary amount the optical axis of each laser beam emitted from one first laser element 111, one second laser element 112, and one third laser element 113 among the plurality of first laser elements 111, the plurality of second laser elements 112, and the plurality of third laser elements 113. Specifically, as shown in FIG. 22, the light source 11 according to the present modified example comprises the plurality of first laser elements 111a, 111b, the plurality of second laser elements 112a, 112b, the plurality of third laser elements 113a, 113b, the first semiconductor chip 114a, 114b, the second semiconductor chip 115a, 115b, the third semiconductor chip 116a, 116b, the drive circuit 117, the first collimate lens 118a, 118b, the second collimate lens 119a, 119b, the third collimate lens 120a, 120b, the multiplexing optical system 121, a first beam shifter 122, a second beam shifter 123, a third beam shifter 124, a first reflection mirror 125, a second reflection mirror 126, a third reflection mirror 127, a first waveplate 128, a second waveplate 129, a third waveplate 130, a first half mirror 131, a second half mirror 132, and a third half mirror 133. The configuration of the first semiconductor chip 114a, 114b, the second semiconductor chip 115a, 115b, the third semiconductor chip 116a, 116b, the drive circuit 117, the first collimate lens 118a, 118b, the second collimate lens 119a, 119b, the third collimate lens 120a, 120b, the multiplexing optical system 121 are similar to that of the second embodiment described above, and description will be omitted. Each of the first laser element 111, the second laser element 112, and the third laser element 113 may include the semiconductor substrate. In this case, it is preferable that the semiconductor substrate, for example, is disposed between the first highly reflective DBR and the second highly reflective DBR which sandwich the active layer. The semiconductor substrate is not limited to such configuration, and may be disposed on the outside of either of the first highly reflective DBR and the second highly reflective DBR.

The plurality of first laser elements 111a, 111b are comprised on the first semiconductor chip 114a, 114b. Likewise, the plurality of second laser elements 111a, 111b are comprised on the second semiconductor chip 115a, 115b. Furthermore, the plurality of third laser elements 113a, 113b are comprised on the third semiconductor chip 116a, 116b.

The first beam shifter 122 is an optical element that shifts the optical axis of the laser beam emitted from the first laser element 111a. Likewise, the second beam shifter 123 is an optical element that shifts the optical axis of the laser beam emitted from the second laser element 112a. Furthermore, the third beam shifter 124 is an optical element that shifts the optical axis of the laser beam emitted from the third laser element 113a. Each beam shifter may use a tilted glass substrate, a biaxial crystal LiNbO3, or a diffractive optical system such as a metamaterial.

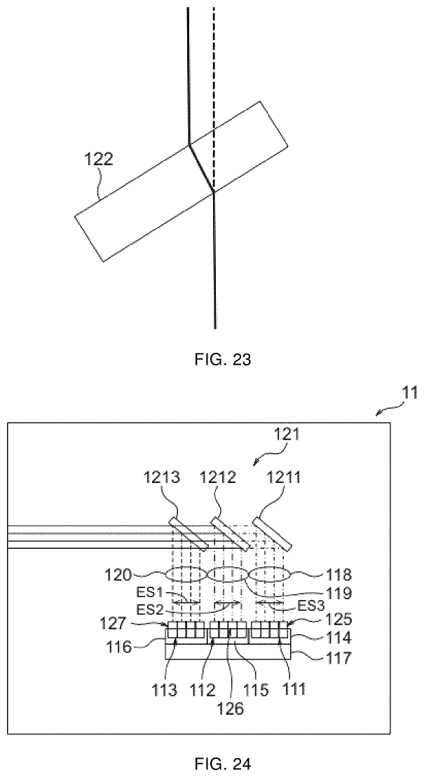

Specifically, as shown in FIG. 23, the first beam shifter 122, the second beam shifter 123, and the third beam shifter 124 shifts the optical axis of the laser beam by refracting and emitting the incident laser beam. The first beam shifter 122, the second beam shifter 123, and the third beam shifter 124 adjusts a shifting amount of the optical axis of the laser beam by changing a tilt based on the control of the light source controller 18. The shifting amount of the laser beam by the first beam shifter 122, the second beam shifter 123, and the third beam shifter 124 is the same.

The first reflection mirror 125 is a mirror that reflects the laser beam emitted by the first beam shifter 122 to the first half mirror 131; the second reflection mirror 126 is a mirror that reflects the laser beam emitted by the second beam shifter 123 to the second half mirror 132; and the third reflection mirror 127 is a mirror that reflects the laser beam emitted by the third beam shifter 124 to the third half mirror 133.

The first waveplate 128 disposed between the first laser element 111b and the first half mirror 131 is an element that changes the polarization direction of the laser beam emitted from the first laser element 111b; the second waveplate 129 disposed between the second laser element 112b and the second half mirror 132 is an element that changes the polarization direction of the laser beam emitted from the second laser element 112b; and the third waveplate 130 disposed between the third laser element 113b and the third half mirror 133 is an element that changes the polarization direction of the laser beam emitted from the third laser element 113b.

The first half mirror 131 disposed between the first reflection mirror 125, the first waveplate 128, and the multiplexing optical system 121 reflects the laser beam of the first laser element 111a reflected by the first reflection mirror 125 to the multiplexing optical system 121 and lets the laser beam of the first laser element 111b that passed through the first waveplate 128 pass through the multiplexing optical system 121.

The second half mirror 132 disposed between the second reflection mirror 126, the second waveplate 129, and the multiplexing optical system 121 reflects the laser beam of the second laser element 112a reflected by the second reflection mirror 126 to the multiplexing optical system 121 and lets the laser beam of the second laser element 112b that passed through the second waveplate 129 pass through the multiplexing optical system 121.

The third half mirror 133 disposed between the third reflection mirror 127, the third waveplate 130, and the multiplexing optical system 121 reflects the laser beam of the third laser element 113a reflected by the third reflection mirror 127 to the multiplexing optical system 121 and lets the laser beam of the third laser element 113b that passed through the third waveplate 130 pass through the multiplexing optical system 121.

With an example of the first laser element 111a, 111b in such light source 11, the laser beam emitted from the first laser element 111a is incident to the first half mirror 131 by passing through the first collimate lens 118a, shifting the optical axis of the laser beam in the beam shifter 122, and being reflected at the first reflection mirror 125. On the other hand, the laser beam emitted from the first laser element 11b passes the first waveplate 128 and is incident to the first half mirror 131. In the first half mirror 131, regarding a reflecting location of the laser beam emitted from the first laser element 111a and the location where the laser beam emitted from the first laser element 111b passes through, for instance, both are in the same location if the optical axis of the laser beam of the first laser element 111 did not shift by the first beam shifter 122; and there is the distance between the laser beam of the first laser element 111a and the first laser beam 111b if the optical axis of the laser beam of the first laser element 111a shifts by the first beam shifter. Accordingly, in the light source 11 according to the present modified example, the separation of the laser beam of each laser element may be controlled by changing the tilt of the beam shifter. This example was given for VCSELs, but the beam shifter may be used for semiconductor lasers of ordinary edge emission.

Note that, in the third modified example of the second embodiment, the light source 11 comprised the plurality of first laser elements 111, the plurality of second laser elements 112, and the plurality of third laser elements 113 and one beam shifter was provided for the plurality of first laser elements 111, the plurality of second laser elements 112, and the plurality of third laser elements 113; but a plurality of beam shifters may be provided for the plurality of first laser elements 111, the plurality of second laser elements 112, and the plurality of third laser elements 113. Specifically, as shown in FIG. 24, the light source 11 may comprise a plurality of first beam shifters 125 that shifts each laser beam emitted from the plurality of first laser elements 111 and disposed between each of the plurality of first laser elements 111 and the multiplexing optical system 121; a plurality of second beam shifters 126 that shifts each laser beam emitted from the plurality of second laser elements 112 and disposed between each of the plurality of second laser elements 112 and the multiplexing optical system 121; and a plurality of third beam shifters 127 that shifts each laser beam emitted from the plurality of third laser elements 113 and disposed between each of the plurality of third laser elements 113 and the multiplexing optical system 121. According to such configuration, the imaging projection device 1 may control the first beam shifter 125, the second beam shifter 126, and the third beam shifter 127 to, for instance, shorten the distance of emitter sizes ES1, ES2, and ES3 to less than or equal to 5 μm˜30 μm and reduce the distance of the light beam

### Modified Fourth Example of the Second Embodiment

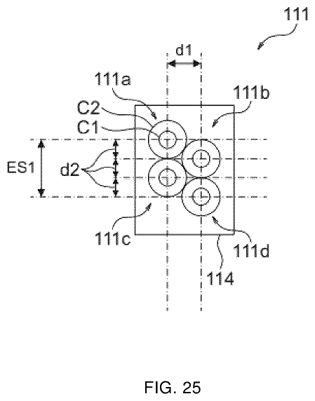

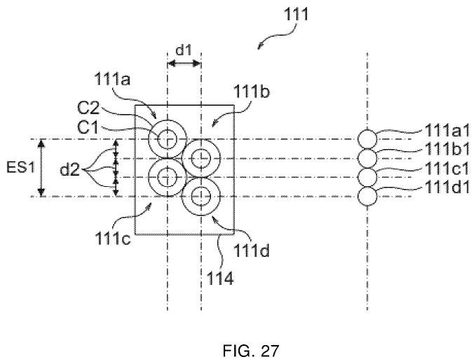

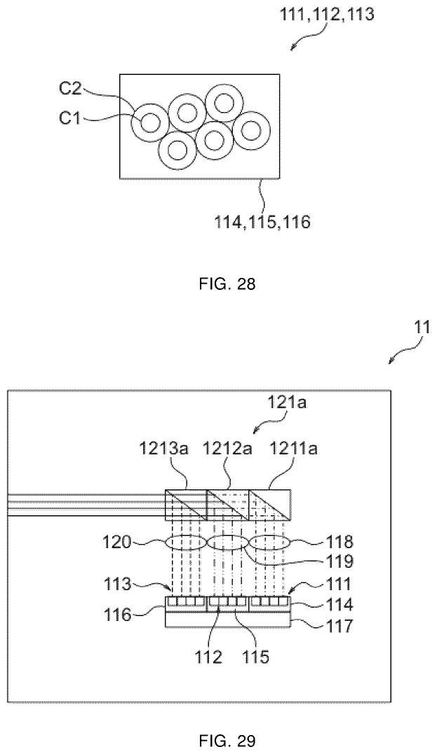

In the second embodiment described above, the plurality of first laser elements 111, the plurality of second laser elements 112, and the plurality of third laser element 113 were arranged in one direction on each semiconductor substrate, but the method of arranging the plurality of first laser elements 111, the plurality of second laser elements 112, and the plurality of third laser element 113 are not limited to this. The plurality of first laser elements 111, the plurality of second laser elements 112, and the plurality of third laser element 113 may be arranged two-dimensionally. Below, a specific configuration of the present modified example will be described with an example of the plurality of first laser elements 111. As shown in FIG. 25, the plurality of first laser elements 111 according to the present modified embodiment comprises four first laser elements 111a˜111d, and the four first laser elements 111a˜111d are arranged two-dimensionally so as to be spaced by a predetermined distance d1 in a first direction and a predetermined distance d2 in a second direction. In the example shown in FIG. 25, the first direction is the main scanning direction, and the second direction is a sub-scanning direction. Specifically, the four first laser elements 111a˜111d arranged to be a zigzag shape such that each of the four first laser elements 111a˜111d contact with the adjacent first laser elements. In FIG. 25, an emitter range among the first laser elements 111a˜111d where laser beams 111a1˜111d1 are emitted is schematically indicated by a circle C1. Also, in FIG. 25, a whole range of the element among the first laser elements 111a˜111d that include wirings nearby the emitter is schematically indicated by a circle C2 that surrounds circle C1. A significance of circles C1 and C2 are similar in FIGS. 27 and 28 which will be described below. Since the first laser elements 111a˜111d are arranged in zigzag shape, the distance between the centers of light-emitting part (i.e. pitch) of the first laser elements 111a˜111d may be made as small as possible, and arbitrary pitches may be created even if the first laser elements 111a˜111d are spread to nearby the emitter.

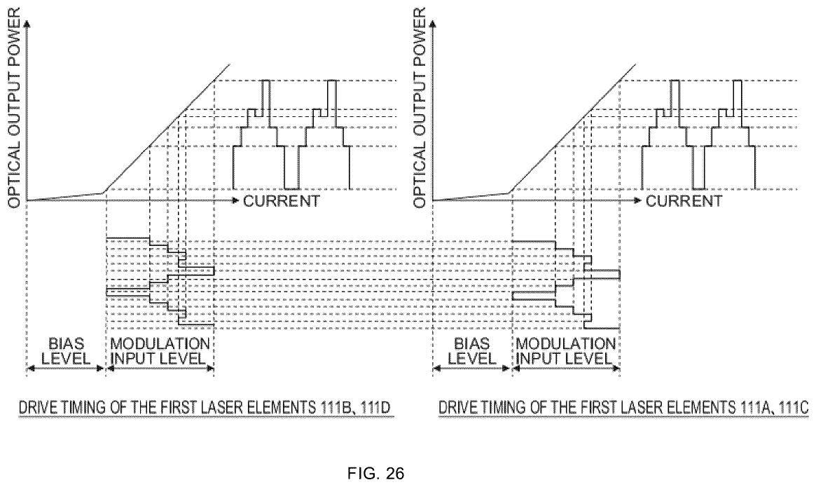

Having the first laser elements 111a˜111d arranged as such, as shown in FIG. 26, the light source controller 18 uses linear modulation to drive the first laser elements 111b, 111d with a first input signal, and drives the first laser elements 111a, 111c with a second input signal for which the phase is delayed from the first input signal. By such, as shown in FIG. 27, images with high resolution may be projected to the user's retina since the laser beams 111a1˜111d1 emitted from each laser elements dose not deviate of the main scanning direction and is projected to the user's retina when the image is projected to the user's retina, even when the plurality of first laser elements 111 is arranged, deviated of the main scanning direction (first scanning direction).

Note that, similarly, the plurality of second laser elements 112 and the plurality of third laser elements 113 may be arranged in zigzag shape such that each of the plurality of second laser elements 112 and the third laser elements 113 contact with the adjacent second laser elements. Also, similar to that of the plurality of first laser elements 111, the light source controller 18 uses linear modulation to drive each of the second laser elements 112 and each of the third laser elements 113.

As such, by arranging the plurality of first laser elements 111, the plurality of second laser elements 112, and the plurality of third laser elements 113 two-dimensionally so as to space by the predetermined distance d1 in the first direction and the predetermined distance d2 in the second direction, the light source 11 may be miniaturized even when the light source 11 comprises the plurality of laser elements. Likewise, the light source 11 may be further miniaturized by arranging the plurality of second laser elements 112 and the plurality of third laser elements 113 in zigzag shape and the first laser elements 111a˜111d in contact with each other.

Note that, in the light source 11 according to the present embodiment, the plurality of first laser elements 111 was arranged to contact with each other, but the first laser elements 111a˜111d may be arranged in zigzag shape without contacting with each other. Likewise, the plurality of second laser elements 112 and the plurality of third laser elements may be arranged in zigzag shape without the second laser elements 112a˜112d and the third laser elements 113a˜113d contacting with each other. Likewise, in the light source 11 according to the present embodiment, the plurality of first laser elements 111, the plurality of second laser elements 112, and the plurality of third laser elements 113 respectively comprise four laser elements, but the number of laser elements is not limited to four. That is, the number of laser elements is arbitrary, and may comprise two or three, or more than or equal to 5. Specifically, as shown in FIG. 28, the plurality of first laser elements 111, the plurality of second laser elements 112, and the plurality of third laser elements 113 may arrange six laser elements in zigzag such that each of the laser elements contact with each other. Since the distance between centers of light-emitting part is further shortened in the example of FIG. 28 compared to that of FIG. 25, the light source may be further miniaturized and there is no need to increase the size D of the MEMS; thus, high resolution may be achieved by the resonance frequency of the main scanning direction reduced by the multi-beam, θopt enlarged, and θopt*D enlarged. Note that, the image projection device 1 may comprise micro beam shifters, and control the distance between pitches by controlling micro beam shifters by arbitrary space. By configuring as such, micro pitches may be realized even when there are six laser beams.

### Modified First Example of First and Second Embodiments

In the first and second embodiments described above, the multiplexing optical system 121 comprised each of the first reflecting optical system 1211, the second reflecting optical system 1212, and the third reflecting optical system 1213, but embodiments are not limited to this. That is to say, there may be a case where the first reflecting optical system 1211, the second reflecting optical system 1212, and the third reflecting optical system 1213 are combined as one. As shown in FIG. 29, the multiplexing optical system 121a may comprise a first reflector 1211a that reflects the laser beam emitted from the first laser element 111 to the scanner 14 side, a second reflector 1212a that reflects the laser beam emitted from the second laser element 112 to the scanner 14 side, and a third reflector 1213a that reflects the laser beam emitted from the third laser element 113 to the scanner 14 side, configured to multiplex each laser beam emitted from the first reflector 1211a, the second reflector 1212a, and the third reflector 1213a on the same optical axis. Note that, in the example shown in FIG. 29, the light source 11 comprised the plurality of first laser elements 111, the plurality of second laser elements 112, and the plurality of third laser elements 113, but the light source 11 may comprise one first laser element 111, one second laser element 112, and one third laser element 113.

### Modified Second Example of the First and Second Embodiments

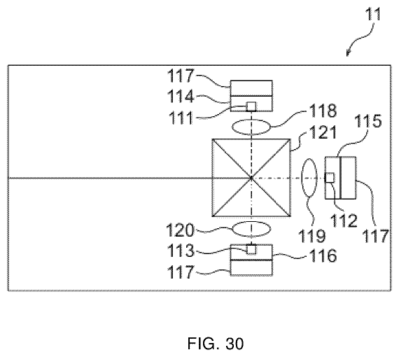

Likewise, the multiplexing optical system 121 may be configured by a cross prism as shown in FIG. 30. When the multiplexing optical system 121 is configured by the cross prism, the drive circuit 117 is comprised on each of the first laser element 111, the second laser element 112, and the third laser element 113 as shown in FIG. 30. Note that, in the example shown in FIG. 30, the first laser element 111, the second laser element 112, and the third laser element 113 respectively comprised one laser element, but may be respectively comprised by the plurality of first laser elements 111, the plurality of second laser elements 112, and the plurality of third laser elements 113.

### Modified Third Example of the First and Second Embodiments

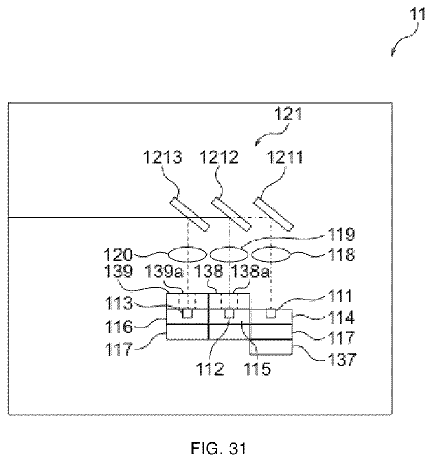

Note that the light source 11 may comprise a heat dissipation plate that dissipates heat arising from the first laser element 111, the second laser element 112, and the third laser element 113. Specifically, as shown in FIG. 31, the light source 11 comprises a first heat dissipation plate 137, a second heat dissipation plate 138, and a third heat dissipation plate 139 in addition to the configuration of the light source 11 shown in FIG. 5.

The drive circuit 117 is the circuit that drives each of the first laser element 111, the second laser element 112, and the third laser element 113. As shown in FIG. 31, the drive circuit 117 is disposed on opposite side to an emitting direction of each of the first laser element 111, the second laser element 112, and the third laser element 113.

The first heat dissipation plate 137 is disposed to contact the surface opposite to the surface where the first laser element 111 in the drive circuit 117 is disposed, the second heat dissipation plate 138 is disposed to contact a surface of the emitting side of the second laser element 112, and the third heat dissipation plate 139 is disposed to contact the surface of the emitting side of the third laser element 113. Note that, as shown in FIG. 31, the second heat dissipation plate 138 and the third heat dissipation plate 139 may have apertures 138a, 139a to emit laser beam.

Note that, in the example shown in FIG. 31, the first laser element 111, the second laser element 112, and the third laser element 113 respectively comprised one laser element, but may be respectively comprised by the plurality of first laser elements 111, the plurality of second laser elements 112, and the plurality of third laser elements 113.

### Modified Fourth Example of the First and Second Embodiments

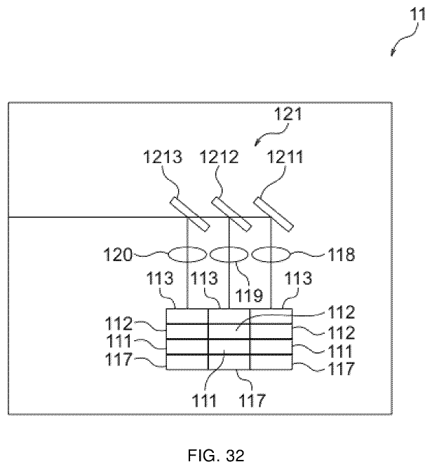

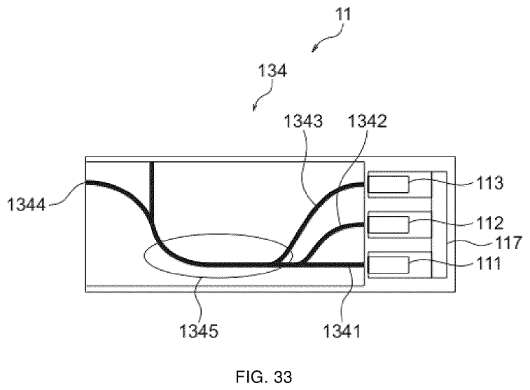

Furthermore, the light source 11 may be disposed to have the first laser element 111 on the drive circuit 117, the second laser element 112 on the first laser element 111, and the third laser element 113 on the second laser element 112. A disposing order of the first laser element 111, the second laser element 112, and the third laser element 113 is in an ascending order of band gap. By taking such structure, a relatively large emitter size may be realized when acquiring a large resolution with a small device size. Note that, in the example shown in FIG. 32, the light source 11 comprised the plurality of first laser elements 111, the plurality of second laser elements 112, and the plurality of third laser elements 113, but may be comprised by one first laser element 111, one second laser element 112, and one third laser element 113.

### Third Embodiment

In the first embodiment described above, the light source 11 multiplexed laser beams respectively emitted from the first laser element 111, the second laser element 112, and the third laser element 113 by comprising the multiplexing optical system 121, but the method of multiplexing the laser beam is not limited to the multiplexing optical system. In the third embodiment, the light source 11 may multiplex laser beams respectively emitted from the first laser element 111, the second laser element 112, and the third laser element 113 by comprising the waveguide type optical multiplexer. Hereinafter, parts that differ from that of the first embodiment described above will be described.

As shown in FIG. 33, The light source 11 according to the present embodiment comprises the first laser element 111, the second laser element 112, the third laser element 113, the drive circuit 117, and the waveguide type optical multiplexer 134.

In the present embodiment, the first laser element 111, the second laser element 112, and the third laser element 113 are VCSEL or edge-emitting laser elements.

The drive circuit 117 is a circuit that drives each of the first laser element 111, the second laser element 112, and the third laser element 113. As shown in FIG. 33, the drive circuit 117 is disposed on an opposite side of an emitting direction of each of the first laser element 111, the second laser element 112, and the third laser element 113.

The waveguide type optical multiplexer 134 has a waveguide 1341˜1343 and an emission outlet 1344.

The waveguide 1341 to 1343 propagates laser beams respectively emitted from the first laser element 111, the second laser element 112, and the third laser element 113, and multiplexes the laser beams respectively emitted from the first laser element 111, the second laser element 112, and the third laser element 113 in a multiplexing area 1345 that multiplexes the propagated laser beams.

The emission outlet 1344 emits the laser beam multiplexed at the multiplexing area 1345 to the scanner 14 side.

As described above, even when comprising the waveguide type optical multiplexer 134 for the light source 11 in the image projection device 1 according to the third embodiment described above, similar to that of the first embodiment, the output of the laser beam may be suppressed, operated with low threshold current, and driven with low power consumption while realizing a stable operation without changing the threshold current value arising from self-heating, since the image projection device 1 is the device of the eye tracking retinal projection type that detects the user's visual line direction and projects the image to the user's retina based on the detected visual line direction.

Likewise, in the third embodiment described above, when the first laser element 111, the second laser element 112, and the third laser element 113 are VCSEL elements, the wavelength hardly changes even when the drive current value is modified, and the image projection device 1 may realize a high color reproducibility.

Likewise, in the third embodiment described above, since the drive circuit 117 is disposed to contact the surface opposite to the integrating surface of the first semiconductor substrate 114, the second semiconductor 115, and the third semiconductor 116, similar to the first embodiment, the capacitance may be reduced, the linear modulation of the first laser element 111, the second laser element 112, and the third laser element 113 fast, and the output stability of each laser element during low gradation realized, and high brightness of the image projected to the user's retina during high gradation realized, intermingling with high speed to realize not only the 10-bit gradation but also the 16-bit gradation. Further, reducing the nearby resolution may decrease power consumption, which allows the low power consumption of the image projection device 1 even when 16-bit gradation is realized.

### Fourth Embodiment

In the third embodiment described above, the light source 11 comprised one waveguide type optical multiplexer, but configurations of the light source 11 is not limited to this. In the fourth embodiment, a plurality of waveguide type optical multiplexers 134 may be used. Hereinafter, parts that differ from that of the third embodiment will be described.

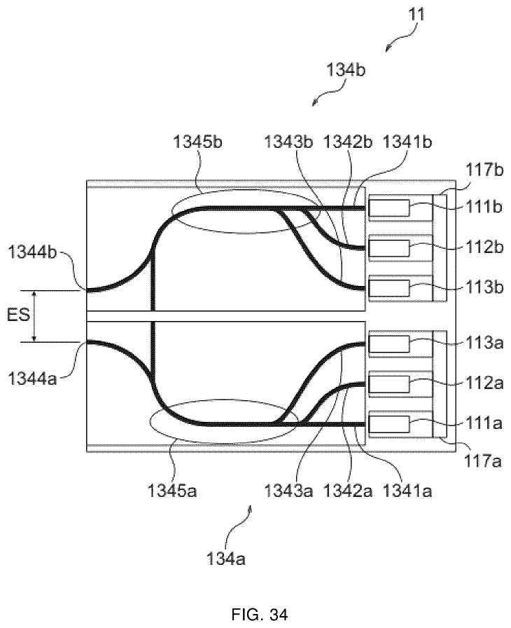

As shown in FIG. 34, the light source 11 according to the present embodiment comprises a first group of first laser elements 111a, a first group of second laser elements 112a, and a first group of third laser elements 113a, a first group of a drive circuit 117a, a first group of waveguide type optical multiplexers 134a, a second group of first laser elements 111b, a second group of second laser elements 112b, a second group of third laser elements 113b, a second group of a drive circuit 117b, and a second group of waveguide type optical multiplexers 134b.

In the present embodiment, the first group of first laser elements 111a, second laser elements 112a, and third laser elements 113a are VCSEL or edge-emitting laser elements.

The first group of the drive circuit 117a is a circuit that drives each of the first group of first laser elements 111a, second laser elements 112a, and third laser elements 113a. As shown in FIG. 34, the drive circuit 117a is disposed on an opposite side of an emitting direction of each of the first group of the first laser element 111a, the second laser element 112a, and the third laser element 113a.

The first group of waveguide type optical multiplexer 134a multiplexes the laser beams emitted from the first group of first laser elements 111a, second laser elements 112a, and third laser elements 113a at the multiplexing area 1345a of waveguides 1341a˜1343a, and emits a first multiplexed beam from the emission outlet 1344a.

The second group of first laser elements 111b, second laser elements 112b, and third laser elements 113b, same with the first group of first laser elements 111a, second laser elements 112a, and third laser elements 113a, are VCSEL or edge-emitting laser elements.

The second group of the drive circuit 117b is a circuit that drives each of the second group of first laser elements 111b, second laser elements 112b, and third laser elements 113b. As shown in FIG. 34, the drive circuit 117b is disposed on an opposite side of an emitting direction of each of the second group of the first laser element 111b, the second laser element 112b, and the third laser element 113b.

The second group of waveguide type optical multiplexer 134b multiplexes the laser beams emitted from the second group of first laser elements 111b, second laser elements 112b, and third laser elements 113b at the multiplexing area 1345b of waveguides 1341b to 1343b, and emits a second multiplexed beam from the emission outlet 1344b.

In the light source 11 according to the present embodiment as shown in FIG. 34, the first group of waveguide type optical multiplexer 134a and the second group of waveguide type optical multiplexer 134b are disposed such that an emitting location of the first and second multiplexed beams are close to each other, by the first laser element 111a, the second laser element 112a, and the third laser element 113a of the first group and the first laser element 111b, the second laser element 112b, and the third laser element 113b of the second group lining up in one direction. At this time, an emitter size ES which is the distance between the centers of the emission outlet 1344a of the first group of waveguide type optical multiplexer 134a and the emission outlet 1344b of the second group of waveguide type optical multiplexer 134b is preferably less than or equal to 90 μm. Likewise, the emitter size ES which is the distance between the centers of the emission outlet 1344a of the first group of waveguide type optical multiplexer 134a and the emission outlet 1344b of the second group of waveguide type optical multiplexer 134b is more preferably less than or equal to 30 μm, and further preferably less than or equal to 5 μm. Especially, the distance may be shortened since the waveguide type optical multiplexer has no thermal interference.

Note that the waveguides 1341a to 1343a and 1341b to 1343b of the waveguide type optical multiplexers 134a, 134b may be modified as shown in FIG. 33, such that the waveguides from the multiplexing areas 1345a, 1345b to the emission outlets 1344a, 1344b have a sharp curve compared to the waveguides 1341 to 1343 of the waveguide type optical multiplexer 134 in the third embodiment as shown in FIG. 34. The output of each laser elements may be less than or equal to 1 mW since the image projection device 1 according to the present embodiment is the eye tracking retinal projection type. For this reason, image may be projected to the user's retina even when there is a loss of laser beam that arises from the sharp curve on the waveguide. Also, potential kinks on the low threshold current may be evaded by having the sharp curve on the waveguide to bring loss on the laser beam and using the first and second multiplexed beam with high current.

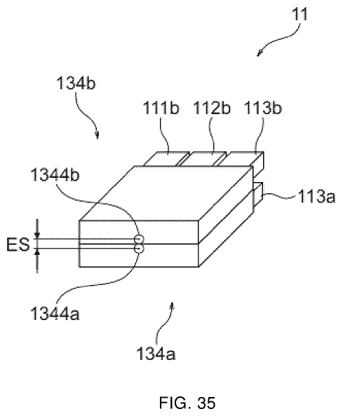

Note that the method of arranging the first group of waveguide type optical multiplexer 134a and the second group of waveguide type optical multiplexer 134b is not limited to this. As shown in FIG. 35, the light source 11 according to the present embodiment may be disposed such that the emitting location of the first and second multiplexed beam are close to each other, by the first group of first laser elements 111a, second laser elements 112a, and third laser elements 113a and the second group of first laser elements 111b, second laser elements 112b, and third laser elements 113b facing each other. Also, at this time, the emitter size ES which is the distance between the centers of the emission outlet 1344a of the first group of waveguide type optical multiplexer 134a and the emission outlet 1344b of the second group of waveguide type optical multiplexer 134b is preferably less than or equal to 90 μm. Likewise, the emitter size ES which is the distance between the centers of the emission outlet 1344a of the first group of waveguide type optical multiplexer 134a and the emission outlet 1344b of the second group of waveguide type optical multiplexer 134b is more preferably less than or equal to 30 μm, and further preferably less than or equal to 5 μm. Note that, the image projection device 1 may comprise micro beam shifters, and control the distance between pitches by controlling micro beam shifters by arbitrary space. Specifically, the optical axis of the first multiplexed beam emitted from the first group of waveguide type optical multiplexer 134a or the optical axis of the second multiplexed beam emitted from the second group of waveguide type optical multiplexer 134b may be shifted to reduce less than or equal to 5 μm distance between 1344a and 1344b.

Likewise, the scanner 14 may achieve higher resolution by reducing the resonance frequency in the main scanning direction, enlarging the optical swing angle θopt, enlarging θopt*D of formula (1) as a result, and scans the laser beam in response to the number of each of the first laser element 111, the second laser element 112, and the third laser element 113. Specifically, as shown in FIGS. 8 and 17, when scanning the laser beam emitted from the emission outlet 1344a of the first group of waveguide type optical multiplexer 134a and the emission outlet 1344b of the second group of waveguide type optical multiplexer 134b, the scanner 14 may reduce the resonance frequency of the MEMS, enlarge θopt*D in formula (1), and increase the resolution of the image projected to the user's retina compared to when the waveguide type optical multiplexer 134 scans one laser beam. That is to say, the resonance frequency in the main scanning direction may be reduced in response to the number of laser elements, θopt*D in formula (1) enlarged, high resolution achieved, and the modulation frequency of the laser element reduced, when the scanner 14 scans the laser beam emitted from the emission outlet 1344a of the first group of waveguide type optical multiplexer 134a and the emission outlet 1344b of the second group of waveguide type optical multiplexer 134b and the resolution of the image projected to the user's retina is the same. Likewise, the light source 11 according to the present embodiment comprises the plurality of first laser elements 111, the second laser elements 112, and the third laser elements 113, and the first group of waveguide type optical multiplexer 134a and the second group of waveguide type optical multiplexer 134b are disposed such that the emitting location of the first and second multiplexed beam are close to each other. For this reason, the scanner 14 reduces the resonance frequency of the main scanning direction, enlarge the optical swing angle θopt, and enlarge θopt*D of formula (1) as the result by using the first group of waveguide type optical multiplexer 134a and the second group of waveguide type optical multiplexer 134b disposed such that the emitting location of the first and second multiplexed beam are close to each other; and scans the laser beam with the luster scanning method such that the image is projected to the user's retina with the resolution higher than HD, i.e. HD, FHD, 2K, and 4K resolution.

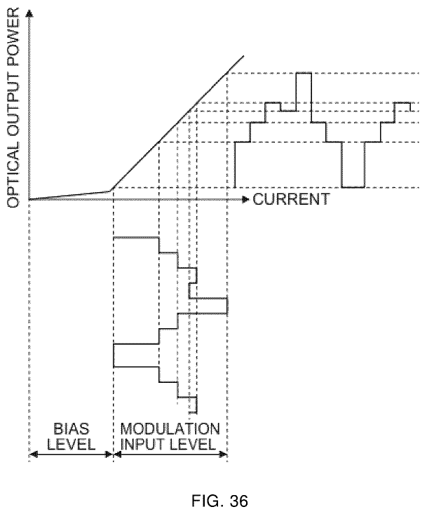

Since the light source 11 according to the present embodiment comprises the plurality of first laser elements 111, the second laser elements 112, and the third laser elements 113, the light source 11 is controlled such that the modulation frequency of each of the plurality of first laser elements 111, the plurality of second laser elements 112, and the plurality of third laser elements 113 is reduced than the modulation frequency when comprising one first laser element 111, one second laser element 112, and one third laser element 113, in response to the number of each of the first laser element 111, the second laser element 112, and the third laser element 113. Specifically, in the case of equivalent frequency, for instance, in the case of projecting images with FHD resolution and 120 Hz framerate with one first laser element 111, one second laser element 112, and one third laser element 113, each of the first laser element 111, the second laser element 112, and the third laser element 113 is required to be controlled by the modulation frequency of 1920*1080*120=250 MHz; but in the case of projecting images with FHD resolution and 120 Hz framerate with two first laser elements 111, two second laser elements 112, and two third laser elements 113, 250 MHz/2=125 MHz is sufficient to control the two first laser elements 111, two second laser elements 112, and two third laser elements 113. That is, as shown in FIG. 36, the modulation frequency of each of the input signal based on image data output to each laser element is reduced since the light source controller 18 comprises the plurality of first laser elements 111, second laser elements 112, and third laser elements 113.

Likewise, the light source controller 18 may control such that the gradation of linear modulation becomes correct gradation by finely adjusting an output of each of the first laser element 111, the second laser element 112, and the third laser element 113 based on the detection result of the photodetector that detects the radiation intensity of the laser beam emitted from the light source 11. Specifically, the light source controller 18 controls the gradation of linear modulation of each of the first laser element 111, the second laser element 112, and the third laser element 113 by generating the correction current to drive the first laser element 111, the second laser element 112, and the third laser element 113 based on the detection result of the photodetector.

Furthermore, the light source controller 18 may control such that the gradation of linear modulation becomes correct gradation by finely adjusting an output of each of the first laser element 111, the second laser element 112, and the third laser element 113 based on the detection result of the temperature sensor that detects the temperature of each of the first laser element 111, the second laser element 112, and the third laser element 113. Specifically, the light source controller 18 controls the gradation of linear modulation of each of the first laser element 111, the second laser element 112, and the third laser element 113 by generating the correction current to drive the first laser element 111, the second laser element 112, and the third laser element 113 based on the detection result of the temperature sensor.

As described above, by the light source 11 in the image projection device 1 according to the present embodiment comprising the plurality of waveguide type optical multiplexers, the power consumption of each laser element per unit time may be reduced, the heat dissipation characteristic may be improved, and the change of oscillation threshold may be further suppressed. Likewise, the power consumption of the driver may also be decreased since the modulation frequency may be reduced.

Likewise, since the light source 11 in the image projection device 1 according to the present embodiment uses the waveguide type optical multiplexer and the multiplexed laser beam incident from the first laser element 111, the second laser element 112, and the third laser element 113 are emitted from one emission outlet, the laser beam may hardly shift.

Likewise, in the image projection device 1 according to the present embodiment, since the first group of waveguide type optical multiplexers 134a and the second group of waveguide type optical multiplexers 134b are disposed such that the emitting location of the first and second multiplexed beam are close to each other, the scanner 14 may reduce the resonance frequency of the main scanning direction, enlarge θopt, and enlarge θopt*D, improving the resolution of the image projected to the user's retina.

Likewise, in the present embodiment, the power consumption of the scanner 14 may be reduced since the scanner may reduce the resonance frequency by having the light source 11 comprise the plurality of waveguide type optical multiplexers.

Likewise, in the present embodiment, by the light source 11 comprising the plurality of waveguide type optical multiplexers, the image projection device 1 may reduce the resonance frequency in main scanning direction of the scanner 14, enlarge θopt, and enlarge θopt*D in response to the number of the plurality of first laser elements 111, the plurality of second laser elements 112, and the plurality of third laser elements 113, and project to the user's retina with the high field of view (FOV). For this reason, the image projection device 1 may enlarge θopt*D while maintaining the resonance frequency in main scanning direction of the scanner 14 and the FOV projected to the user's retina, to improve the resolution of the image projected to the user's retina.

Likewise, in the present embodiment, since the light source 11 comprises the plurality of waveguide type optical multiplexers, the image projection device 1 may reduce the resonance frequency in main scanning direction, enlarge θopt*D in formula (1) in response to the number of the first laser element 111, the second laser element 112, and the third laser element 113, and project the high-resolution image to the user's retina. For this reason, since the resonance frequency in the main scanning direction is proportional to the product of the framerate and the vertical resolution, the image projection device 1 may maintain the resonance frequency in main scanning direction of the scanner 14 and the resolution of the image projected to the user's retina to improve the framerate in response to the number of the first laser element 111, the second laser element 112, and the third laser element 113.

Furthermore, in the present embodiment, since the light source 11 the plurality of first laser elements 111, second laser elements 112, and third laser elements 113, the light source 18 controls the light source 11 such that the modulation frequency of each of the plurality of first laser elements 111, the plurality of second laser elements 112, and the plurality of third laser elements 113 is reduced than the modulation frequency of each of one first laser element 111, one second laser element 112, and one third laser element 113, when one first laser element 111, one second laser element 112, and one third laser element 113 are provided. By such, the light source 11 may improve a controllability of linear modulation and increase the number of bit gradation for the image projected to the retina.

### Modified Example of the Fourth Embodiment

In the fourth embodiment described above, since the light source 11 comprises the plurality of first laser elements 111, second laser elements 112, and third laser elements 113, the modulation speed of each laser element may be reduced. Likewise, from that the drive current of each laser element may be small because the image projection device 1 is the device that projects the image to the user's retina, since precise gradation control in low gradation, waveform distortion, or overshoot may be reduced by performing control of micro current when performing linear modulation, the gradation of the image may be increased, and precise control becomes possible in high gradation since there may be more room for the laser output, which increases the brightness. Accordingly, in the fourth embodiment described above, the light source controller 18 allows arbitrarily controlling the gradation number of linear modulation of each of the plurality of first laser elements 111, the plurality of second laser elements 112, and the plurality of third laser elements 113 such that the gradation of the image projected to the user's retina becomes greater than or equal to 12-bit and less than or equal to 16-bit.

Furthermore, the light source controller 18 may control the modulation frequency of each of the plurality of first laser elements 111, the plurality of second laser elements 112, and the plurality of third laser elements 113 to project the High Dynamic Range (HDR) image to the user's retina such that the gradation of the image projected to the user's retina becomes greater than or equal to 12-bit and less than or equal to 16-bit. Especially, since the device is that of an eye tracking retinal projection method, it becomes possible to increase the gradation or resolution of the image information corresponding to the visual line direction, i.e. mitigating the load of image processing by decreasing the gradation and resolution outside the visual line direction.

### Modified Example of the Third and Fourth Embodiments

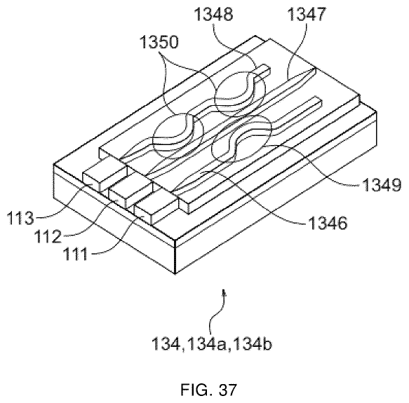

As shown in FIG. 37, the waveguide type optical multiplexer 134, 134a, and 134b in the third and fourth embodiments described above may comprise a first waveguide 1346 that incidents the laser beam of the first laser element 111, a second waveguide 1347 that incidents the laser beam of the second laser element 112, a third waveguide 1348 that incidents laser beam of the third laser element 113, a first multiplexer 1349 that propagates the laser beam between the first and second waveguides, and a second multiplexer 1350 that propagates the laser beam between the third and first waveguides.

Note that the figures described above, especially FIGS. 13 and 29, are diagrams that describe an overview of how each optical system and each laser element are disposed. Actual dimensions and allocations of each optical system and each laser element depicted in the figures may be different.

In the description of embodiments of the present disclosure, it is to be understood that terms such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise” and “counterclockwise” should be construed to refer to the orientation or the position as described or as shown in the drawings under discussion. These relative terms are only used to simplify description of the present disclosure, and do not indicate or imply that the device or element referred to must have a particular orientation, or constructed or operated in a particular orientation. Thus, these terms cannot be constructed to limit the present disclosure.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present disclosure, “a plurality of” means two or greater than two, unless specified otherwise.

In the description of embodiments of the present disclosure, unless specified or limited otherwise, the terms “mounted”, “connected”, “coupled” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the embodiments of the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on”, “above” or “on top of” a second feature may include an embodiment in which the first feature is right or obliquely “on”, “above” or “on top of” the second feature, or just means that the first feature is at a height higher than that of the second feature; while a first feature “below”, “under” or “on bottom of” a second feature may include an embodiment in which the first feature is right or obliquely “below”, “under” or “on bottom of” the second feature, or just means that the first feature is at a height lower than that of the second feature.

Various embodiments and examples are provided in the above description to implement different structures of the present disclosure. In order to simplify the present disclosure, certain elements and settings are described in the above. However, these elements and settings are only by way of example and are not intended to limit the present disclosure. In addition, reference numbers and/or reference letters may be repeated in different examples in the present disclosure. This repetition is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

Reference throughout this specification to “an embodiment”, “some embodiments”, “an exemplary embodiment”, “an example”, “a specific example” or “some examples” means that a particular feature, structure, material, or characteristic described in connection with the embodiment or example is included in at least one embodiment or example of the present disclosure. Thus, the appearances of the above phrases throughout this specification are not necessarily referring to the same embodiment or example of the present disclosure. Furthermore, the particular features, structures, materials, or characteristics may be combined in any suitable manner in one or more embodiments or examples.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which it should be understood by those skilled in the art that functions may be implemented in a sequence other than the sequences shown or discussed, including in a substantially identical sequence or in an opposite sequence.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although embodiments of the present disclosure have been shown and described, it would be appreciated by those skilled in the art that the embodiments are explanatory and cannot be construed to limit the present disclosure, and changes, modifications, alternatives and variations can be made in the embodiments without departing from the scope of the present disclosure.

What is claimed is:

1. An image projection device comprising:
a light source that irradiates a laser beam;
a scanner that scans the laser beam irradiated from the light source;
a projection optical system that irradiates the laser beam scanned by the scanner and projects an image to a user's retina;
a visual line direction detector that detects a user's visual line direction for which the image is projected; and
an optical system controller that controls the projection optical system based on the visual line direction detected by the visual line direction detector,
wherein the light source comprises:
at least one first laser element that irradiates a laser of a first color,
at least one second laser element that irradiates a laser of a second color different from the first color, and
at least one third laser element that irradiates a laser of a third color different from the first and the second colors.

2. The image projection device of claim 1, wherein each of the first, second, and third laser element is a vertical cavity surface emitting laser (VCSEL) element, or an edge-emitting laser element; and
wherein the first laser element has a first active layer, the second laser element has a second active layer, the third laser element has a third active layer, the first active layer includes Aluminum Gallium Indium Phosphide (InGaAlP), and the second and third active layers includes Indium Gallium Nitride (InGaN).

3. The image projection device of claim 1, wherein an optical output power of each of the first, second, and third laser elements is less than or equal to 1 mW, and a threshold current of each of the first, second, and third laser elements is less than or equal to 6 mA.

4. The image projection device of claim 1, wherein the light source comprises a plurality of each of the first, second, and third laser elements; and
wherein the plurality of first, second, and third laser elements are respectively integrated on a same semiconductor substrate.

5. The image projection device of claim 1, wherein the light source comprises:
a drive circuit that drives the first, second, and third laser elements, disposed on opposite side to an emitting direction of each of the first laser element, the second laser element, and the third laser element;
a first heat dissipation plate disposed to contact a surface opposite to a surface where a semiconductor substrate of the first laser element in the drive circuit is disposed;
a second heat dissipation plate disposed to contact a surface of an emitting side of the semiconductor substrate of the second laser element; and
a third heat dissipation plate disposed to contact the surface of the emitting side of the semiconductor substrate of the third laser element;
wherein the second and third heat dissipation plates comprise an aperture to emit the laser beam.

6. The image projection device of claim 1, wherein the light source further comprises a drive circuit that drives the first, second, and third laser elements; and, wherein
the first laser element is disposed on the drive circuit;
the second laser element is disposed on the first laser element; and
the third laser element is disposed on the second laser element.

7. The image projection device of claim 1, wherein the light source comprises:
a plurality of each of the first, second, and third laser elements; and
a drive circuit that drives the first, second, and third laser elements;
wherein each of the plurality of the first, second, and third laser elements are arranged on the drive circuit in one direction.

8. The image projection device of claim 1, wherein the light source comprises:
a first laser element group comprising a plurality of first laser elements;
a second laser element group comprising a plurality of second laser elements; and
a third laser element group comprising a plurality of third laser elements,
wherein an emitter size, which is a distance between the centers of light-emitting part of two laser elements separated away the furthest among each laser element group of the first, second, and third laser element groups, is less than or equal to 90 μm.

9. The image projection device of claim 1, wherein the light source further comprises a multiplexing optical system that incidents and multiplexes the laser beam emitted from each of the at least one first, second, and third laser element.

10. The image projection device of claim 9, wherein the multiplexing optical system comprises:
a first reflecting optical system disposed to reflect the laser beam emitted from the first laser element to a scanner side;
a second reflecting optical system disposed to reflect the laser beam emitted from the second laser element to the scanner side; and
a third reflecting optical system disposed to reflect the laser beam emitted form the third laser element to the scanner side,
wherein the first, second, and third reflecting optical systems are disposed such that the laser beam reflected by each of the first, second, and third reflecting optical systems are multiplexed on a same optical axis.

11. The image projection device of claim 9, wherein the light source comprises:
a first collimate lens disposed between the first laser element and the multiplexing optical system, that collimates the laser beam emitted from the first laser element;
a second collimate lens disposed between the second laser element and the multiplexing optical system, that collimates the laser beam emitted from the second laser element; and
a third collimate lens disposed between the third laser element and the multiplexing optical system, that collimates the laser beam emitted from the third laser element,
wherein the first, second, and third collimate lens collimates the laser beams to have a same beam diameter.

12. The image projection device of claim 9, wherein the light source comprises:
a plurality of the first, second, and third laser elements;
a first collimate lens disposed between the first laser element and the multiplexing optical system, that collimates the laser beam emitted from the first laser element;
a second collimate lens disposed between the second laser element and the multiplexing optical system, that collimates the laser beam emitted from the second laser element; and
a third collimate lens disposed between the third laser element and the multiplexing optical system, that collimates the laser beam emitted from the third laser element.

13. The image projection device of claim 11, wherein the first, second, and third collimate lenses are diffraction lenses; or
wherein the first, second, and third collimate lenses are meta lenses, and the meta lenses are disposed to contact an emitting surface of each of the first, second, and third laser elements.

14. The image projection device of claim 9, further comprising:
a plurality of each of the first, second, and third laser elements;
a first beam shifter disposed between the plurality of first laser elements and the multiplexing optical system, that shifts an optical axis of the laser beam emitted from one first laser element;
a second beam shifter disposed between the plurality of second laser elements and the multiplexing optical system, that shifts an optical axis of the laser beam emitted from one second laser element; and
a third beam shifter disposed between the plurality of third laser elements and the multiplexing optical system, that shifts an optical axis of the laser beam emitted from one third laser element

15. The image projection device of claim 1, wherein the light source comprises a waveguide type optical multiplexer that incidents into the waveguide and multiplexes the laser beams emitted from each of the first, second, and third laser elements.

16. The image projection device of claim 15, wherein the waveguide type optical multiplexer comprises:
a first group of waveguide type optical multiplexers that multiplexes the laser beams emitted from a first group of first, second, and third laser elements by being incident into the waveguide, and emits a first multiplexed beam; and
a second group of waveguide type optical multiplexers that multiplexes the laser beams emitted from a second group of first, second, and third laser elements by being incident into the waveguide, and emits a second multiplexed beam;
wherein the first and second groups of waveguide type optical multiplexers are disposed such that the emitting location of the first and second multiplexed beams are close to each other; and
wherein an emitter size, which is a distance between the centers of distance between the centers of the emission outlet of the first group of waveguide type optical multiplexers and the emission outlet of the second group of waveguide type optical multiplexers, is less than or equal to 90 μm.

17. The image projection device of claim 1, further comprising a light source controller that controls the laser beam emitted from the light source; wherein the light source controller controls the light source to control a resolution of an image projected to the user's retina, based on the visual line direction detected by the visual line direction detector; and the light source controller controls the light source to enable the resolution of an image outside a predetermined area for an image projected in the user's visual line direction to be lower than the resolution of the image within the predetermined area.

18. The image projection device of claim 1, comprising a light source controller that controls the laser beam emitted from the light source;
wherein the light source comprises a plurality of each of the first, second, and third laser elements;
wherein the light source controller controls the light source such that a modulation frequency of each of the plurality of the first, second, and third laser elements are reduced compared to a modulation frequency of each of one first, second, and third laser elements when the light source comprises one first laser element, one second laser element, and one third laser element, in response to the number of each of the first, second, and third laser elements.

19. The image projection device of claim 1, wherein the projection optical system comprises a plurality of reflection mirrors,
wherein the plurality of reflection mirrors comprise a tilt mirror module that includes a tilt mirror that reflects the laser beam emitted from the light source to the user's retina; and
wherein the light source controller projects the laser beam to the user's retina by controlling the tilt mirror module based on the visual line direction detected by the visual line direction detector;
wherein the tilt mirror module further comprises:
a movable body that comprises the tilt mirror,
a gimbal mechanism that supports the movable body to oscillate the tilt mirror; and
a magnetic drive mechanism that oscillates the movable body; and
wherein the image projection device further comprises an angle velocity sensor that detects an angle velocity of the image projection device, wherein the light source controller controls the magnetic drive mechanism based on a detection result of the angle velocity sensor.

20. The image projection device of claim 1, further comprising a plurality of each of the first, second, and third laser elements;
wherein each of the first, second, and third laser elements are arranged in zigzag shape; or
wherein the light source comprises a plurality of each of the first, second, and third laser elements, each laser element of the plurality of the first, second, and third laser elements are separated by a predefined space; and the scanner scans the laser beam with a luster scanning method such that a resonance frequency in a main scanning direction is reduced and an image is projected to the user's retina with a resolution higher than HD, by using the light source where each laser element of the plurality of the first, second, and third laser elements are separated by the predefined space.
